(19) United States
(12) Patent Application Publication
(10) Pub. No.: US 2025/0320240 A1
(43) Pub. Date: Oct. 16, 2025

(54) SCALABLE METHODS OF MANUFACTURING PSILOCYBIN

(71) Applicant: Compass Pathfinder Limited, Altrincham (GB)

(72) Inventors: Ronnie Maxwell LAWRENCE, Bedfordshire (GB); Jonathan Charles Christian ATHERTON, County Durham (GB); Michal CZYZEWSKI, Durham (GB)

(21) Appl. No.: 19/175,672

(22) Filed: Apr. 10, 2025

Related U.S. Application Data
(60) Provisional application No. 63/633,440, filed on Apr. 12, 2024.

(51) Int. Cl. C07F 9/572; C07B 49/00

(52) U.S. Cl. CPC C07F 9/5728; C07B 49/00; C07B 2200/13

(57) ABSTRACT

The present disclosure provides methods of manufacturing psilocybin and crystalline psilocybin via a reaction of psilocin and tetrabenzylpyrophosphate in the presence of lithium chloride complex Grignard reagent, which is followed by hydrogenation. Methods of producing psilocin from 4-hydroxyindole or 4-acetoxyindole are also provided.

This application claims priority to U.S. Provisional Application No. 63/633,440, filed Apr. 12, 2024, the disclosure of which is incorporated by reference in its entirety for all purposes.

### BACKGROUND

Psilocybin was first synthesized in 1958 by Sandoz and was widely available as a research chemical until the mid-1960's. As a plant-based psychedelic, psilocybin has been used as an aide to psychotherapy for the treatment of mood disorders and alcoholic disorders. Recently, its use for depressive symptoms such as treatment-resistant depression (TRD), post-traumatic stress disorder (PTSD), and anorexia nervosa have been investigated through various clinical trials.

Though psilocybin is a naturally occurring molecule, it is important to develop a scalable and reproducible synthetic process for manufacturing chemically pure psilocybin suitable for medical use. There remains a need in the art for improved methods for the manufacture of psilocybin and crystalline psilocybin.

### SUMMARY

In one aspect, the present disclosure is directed to a scalable method of manufacturing psilocybin from psilocin, 4-acetoxyindole, or 4-hydroxyindole. In one aspect, the disclosure provides for a crystalline form of the psilocybin.

In embodiments, the method comprises: (i) mixing psilocin and tetrabenzylpyrophosphate (TBPP) in the presence of a Grignard reagent to form a reaction mixture; and (ii) subjecting the reaction mixture to hydrogen in the presence of a catalyst to form psilocybin, wherein the Grignard reagent is a lithium chloride complex Grignard reagent of Formula (I)

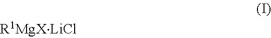

wherein:
R¹ is optionally substituted C₁-C₁₂ alkyl, optionally substituted C₂-C₁₂ alkenyl, optionally substituted C₂-C₁₂ alkynyl, optionally substituted C₃-C₉ cycloalkyl, or optionally substituted C₆-C₁₈ aryl; and
X is Cl, Br, or I.

In embodiments, the method further comprises (iii) crystallizing psilocybin from water, thereby forming a crystalline form of psilocybin.

In embodiments, R¹ of Formula (I) is optionally substituted C₁-C₄ alkyl. In embodiments, R¹ is methyl, ethyl, n-propyl, isopropyl, n-butyl, isobutyl, or tert-butyl. In embodiments, R¹ is isopropyl. In embodiments, X of Formula (I) is Cl. In embodiments, the Grignard reagent is isopropylmagnesium chloride lithium chloride complex ((CH₃)₂CHMgCl·LiCl).

In embodiments, the mixing in step (i) of the method is performed in an organic solvent. In embodiments, the organic solvent is tetrahydrofuran (THF).

In embodiments, the mixing in step (i) is performed at a temperature greater than −50° C. In embodiments, the mixing in step (i) is performed at a temperature from about −10° C. to about 25° C. In embodiments, the mixing in step (i) is performed at a temperature from about 0° C. to about 13° C., from about 1° C. to about 11° C., or about 6° C.

In embodiments, the mixing in step (i) of the method is performed for up to 4 hours. In embodiments, the mixing in step (i) is performed for 0.5 hours to 2 hours.

In embodiments, the mixing in step (i) comprises: (i-1) mixing psilocin and the Grignard reagent to form a first mixture; and (i-2) mixing TBPP with the first mixture to form the reaction mixture. In embodiments, the first mixture is formed by mixing psilocin and the Grignard reagent at a temperature greater than −50° C. for up to 2 hours. In embodiments, the first mixture is formed by mixing psilocin and the Grignard reagent at a temperature from about −10° C. to about 25° C. for up to 2 hours. In embodiments, the first mixture is formed by mixing psilocin and the Grignard reagent at a temperature from about 0° C. to about 13° C., from about 1° C. to about 11° C., or about 6° C. for 0.5 hours to 1 hour, 10 to 20 minutes, or about 15 minutes.

In embodiments, a molar ratio of the Grignard reagent to psilocin ranges from about 1:1 to about 2:1. In embodiments, a molar ratio of the Grignard reagent to psilocin ranges from 1.1:1 to 1.4:1. In embodiments, a molar ratio of the TBPP to psilocin ranges from about 1:1 to about 3:1. In embodiments, a molar ratio of the TBPP to psilocin ranges from 1.2:1 to 1.5:1, or from 1.3:1 to 1.4:1.

In embodiments, step (i) further comprises quenching the reaction mixture with water or an aqueous solution prior to step (ii). In embodiments, the quenching prior to step (ii) comprises: (i-3) mixing the reaction mixture of step (i) with a water or an aqueous solution at a temperature below 25° C. for less than 30 minutes to form an aqueous layer and an organic layer; and (i-4) collecting the reaction mixture which is present in the organic layer.

In embodiments, benzyl 3-[2-(benzyldimethylazaniumyl)ethyl]-1H-indol-4-yl phosphate is not isolated in the method described herein.

In embodiments, the catalyst in step (ii) is a palladium on carbon (Pd/C) catalyst.

In embodiments, the crystallization in step (iii) comprises: combining the psilocybin and about 10-20 volumes of water to form an aqueous mixture; heating the aqueous mixture with agitation to a temperature of at least 70° C., such as 70° C. to 80° C., to provide a solution; filtering the solution to form a filtered solution; seeding the filtered solution at a temperature of about 59-68° C., about 61-67° C., or about 70° C. to form a seeded suspension; cooling the seeded suspension to a temperature of about 5° C. over a period of more than 2 hours to form a cooled suspension; filtering the cooled suspension to form a solid, and drying the solid, thereby forming the crystalline form of psilocybin. In embodiments, the filtering is polish filtering. In embodiments, the seeding comprises adding crystalline hydrate of psilocybin to the filtered solution, wherein the crystalline hydrate of psilocybin is characterized by X-ray powder diffraction (XRPD) peaks at 8.9±0.1, 13.8±0.1, 19.4±0.1, 23.1±0.1, and 23.5±0.1°2θ.

In embodiments, the present disclosure further provides methods of preparing psilocin from 1H-indol-4-yl acetate (4-acetoxyindole), which can be prepared from 4-hydroxyindole. In embodiments, the psilocin is manufactured by a method comprising: (1) reacting 1H-indol-4-yl acetate with oxalyl chloride and dimethylamine to form 3-([(dimethylcarbamoyl)carbonyl])-1H-indol-4-yl acetate; and (2) reacting 3-([(dimethylcarbamoyl)carbonyl)-1H-indol-4-yl acetate with lithium aluminum hydride to form psilocin. In embodiments, step (1) comprises: (1-a) reacting 1H-indol-4-yl acetate with oxalyl chloride to form 3-(2-chloro-2-oxoacetyl)-1H-indol-4-yl acetate; and (1-b) reacting the 3-(2-chloro-2-oxoacetyl)-1H-indol-4-yl acetate with dimethylamine to form 3-([(dimethylcarbamoyl)carbonyl])-1H-indol-4-yl acetate. In embodiments, the reaction in step (1-a) is conducted in a mixture of tert-butyl methyl ether (TBME) and THF. In embodiments, the reaction in step (1-a) is conducted at a temperature from about 30° C. to about 40° C. In embodiments, dimethylamine is used in excess in step (1-b).

In embodiments, the yield of psilocybin from psilocin is about 50% or greater. In embodiments, the yield of psilocybin from 1H-indol-4-yl acetate is about 25% or greater.

In embodiments, the crystalline form of psilocybin (Anhydrate Form A) is characterized by XRPD peaks at 11.5±0.1, 12.0±0.1, 14.5±0.1, 17.5±0.1, and 19.7±0.1° 2θ. In embodiments, the yield of the crystalline form of psilocybin from psilocin is about 40% or greater.

In embodiments, the psilocybin has a chemical purity of greater than 99% as determined by HPLC analysis. In embodiments, the psilocybin has a chemical purity of at least 99.3%, 99.5% or 99.9% as determined by HPLC analysis.

In embodiments, the method manufactures the crystalline form of psilocybin at a scale greater than 500 g.

In another aspect, the present disclosure is directed to a method of manufacturing psilocybin and crystalline form of psilocybin from psilocin. The method comprises: (i) mixing psilocin and TBPP in the presence of isopropylmagnesium chloride lithium chloride complex ((CH₃)₂CHMgCl·LiCl) at a temperature from about −10° C. to about 25° C. or from about 1° C. to about 11° C., to form a reaction mixture; and (ii) subjecting the reaction mixture to hydrogen in the presence of a catalyst to form psilocybin. In embodiments, the method further comprises (iii) crystallizing the psilocybin from water, thereby forming a crystalline form of psilocybin.

### BRIEF DESCRIPTION OF THE DRAWINGS

FIG. 1A is a reaction scheme summarizing manufacture of psilocybin from 4-acetoxyindole. Abbreviations: aq: aqueous; H₂: hydrogen; H₂O: water; HCl: hydrochloric acid; iPrOAc: isopropyl acetate; LiAlH₄: lithium aluminium hydride; MeOH: methanol; NaCl: sodium chloride; iPrMgCl·LiCl: isopropylmagnesium chloride lithium chloride complex; NaOH: sodium hydroxide; Pd/C: palladium on activated charcoal support; TBPP: tetrabenzylpyrophosphate; TBME: tert-butyl methyl ether; THF: tetrahydrofuran.

FIG. 1B is a reaction scheme summarizing a modified procedure for the manufacture of psilocybin from 4-acetoxyindole. Abbreviations: aq: aqueous; H₂: hydrogen; H₂O: water; HCl: hydrochloric acid; iPrOAc: isopropyl acetate; LiAlH₄: lithium aluminium hydride; MeOH: methanol; NaCl: sodium chloride; iPrMgCl·LiCl: isopropylmagnesium chloride lithium chloride complex; NaOH: sodium hydroxide; Pd/C: palladium on activated charcoal support; TBPP: tetrabenzylpyrophosphate; TBME: tert-butyl methyl ether; THF: tetrahydrofuran.

FIG. 2 illustrates the Stage 0 reaction of the present disclosure.

FIG. 3 illustrates the Stage 1 reaction (steps (1-a)-(1-b)) of the present disclosure.

FIG. 4 illustrates the Stage 2 reaction (step (2)) of the present disclosure.

FIG. 5 illustrates the Stage 3 reaction (steps (i)-(ii)) of the present disclosure.

FIG. 6 illustrates the Stage 4 (step (iii)) reaction of the present disclosure.

FIG. 7 is a XRPD (X-Ray Powder Diffraction) diffractogram of crystalline form of psilocybin (Anhydrate Form A) manufactured by the method disclosed herein.

FIG. 8 is a DSC (Differential Scanning Calorimetry) and TGA (Thermogravimetric Analysis) thermograph of crystalline form of psilocybin (Anhydrate Form A) manufactured by the method disclosed herein.

FIG. 9 is a XRPD diffractogram of a crystalline hydrate of psilocybin (Hydrate Form A) used by the method disclosed herein.

FIG. 10 is a DSC and TGA thermograph of a crystalline hydrate of psilocybin (Hydrate Form A) used by the method disclosed herein.

### DETAILED DESCRIPTION

The synthesis of psilocybin via the reaction of psilocin and tetrabenzylpyrophosphate (TBPP) using sodium hexamethyldisilazide (NaHMDS) as base has been reported by U.S. Pat. No. 11,505,564, incorporated herein by reference in its entirety. The NaHMDS process requires cryogenic conditions (<−60° C.) for control of the impurity profile. However, cryogenic conditions may not be feasible on commercial scale. As such, there remains a need for an improved method for the manufacture of psilocybin and a crystalline psilocybin, e.g., “Anhydrate Form A”, which can be performed under more practical (non-cryogenic), commercial scale conditions without sacrificing product yield or quality.

It has been surprisingly found that the use of lithium chloride complex Grignard reagent described herein (i.e., “Turbo Grignard”) is advantageous. For example, use of isopropylmagnesium chloride lithium chloride complex as base provides a greater yield of psilocybin and allows reduced formation of impurities. In particular, it is believed that using the Turbo Grignard reagent obviates a need to isolate COM360-04B (benzyl 3-[2-(benzyldimethylazaniumyl)ethyl]-1H-indol-4-yl phosphate),

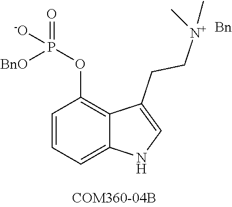

as observed during reactions with other bases (e.g., NaHMDS, see Examples 2-4).

An additional advantage of the presently disclosed process is that the use of Grignard reagent allows the reaction to be performed at a temperature within the range of 1° C. to 11° C. or 0° C. to 5° C. As such, the use of cryogenic conditions and equipment typically required in the prior processes (e.g., the ones using NaHMDS (−50° C. to −70° C.) or ⁿBuLi (−78° C.)) are unnecessary. Notably, regular Grignard reagents such as iPrMgCl may allow reactions to be conducted at higher temperature, however the use of iPrMgCl results in elevated levels of impurities including 5-10% COM360-04E,

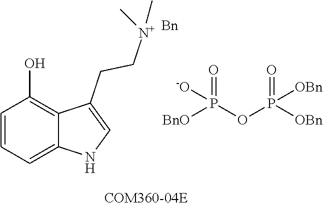

which is subsequently converted to starting material COM360-03 (see Example 4).

### Definitions

For convenience, certain terms employed in the specification, examples and claims are collected here. Unless defined otherwise, all technical and scientific terms used in this disclosure have the same meanings as commonly understood by one of ordinary skill in the art to which this disclosure belongs.

Throughout this disclosure, various patents, patent applications and publications are referenced. The disclosures of these patents, patent applications and publications in their entireties are incorporated into this disclosure by reference for all purposes in order to more fully describe the state of the art as known to those skilled therein as of the date of this disclosure. This disclosure will govern in the instance that there is any inconsistency between the patents, patent applications and publications cited and this disclosure.

The term “about” when immediately preceding a numerical value means a range (e.g., plus or minus 10% of that value). For example, “about 50” can mean 45 to 55, “about 25,000” can mean 22,500 to 27,500, etc., unless the context of the disclosure indicates otherwise, or is inconsistent with such an interpretation. For example, in a list of numerical values such as “about 49, about 50, about 55, . . . ”, “about 50” means a range extending to less than half the interval(s) between the preceding and subsequent values, e.g., more than 49.5 to less than 50.5. Furthermore, the phrases “less than about” a value or “greater than about” a value should be understood in view of the definition of the term “about” provided herein. Similarly, the term “about” when preceding a series of numerical values or a range of values (e.g., “about 10, 20, 30” or “about 10-30”) refers, respectively to all values in the series, or the endpoints of the range.

When a range of values is listed, it is intended to encompass each value and sub-range within the range. For example, “C₁-C₆ alkyl” is intended to encompass C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

The term “Halo,” “halogen” or “halide” refers to fluoro (—F), chloro (—Cl), bromo (—Br), and iodo (—I).

The term “alkyl” or “alkyl group” refers to a fully saturated, straight or branched hydrocarbon chain radical having from one to twelve carbon atoms, and which is attached to the rest of the molecule by a single bond. Alkyls comprising any number of carbon atoms from 1 to 50 are included. An alkyl comprising up to 50 carbon atoms is a C₁-C₅₀ alkyl, an alkyl comprising up to 24 carbon atoms is a C₁-C₂₄ alkyl, an alkyl comprising up to 12 carbon atoms is a C₁-C₁₂ alkyl, an alkyl comprising up to 10 carbon atoms is a C₁-C₁₀ alkyl, an alkyl comprising up to 6 carbon atoms is a C₁-C₆ alkyl and an alkyl comprising up to 5 carbon atoms is a C₁-C₅ alkyl. A C₁-C₅ alkyl includes C₅ alkyls, C₄ alkyls, C₃ alkyls, C₂ alkyls and C₁ alkyl (i.e., methyl). A C₁-C₆ alkyl includes all moieties described above for C₁-C₅ alkyls but also includes C₆ alkyls. A C₁-C₁₀ alkyl includes all moieties described above for C₁-C₅ alkyls and C₁-C₆ alkyls, but also includes C₇, C₈, C₉ and C₁₀ alkyls. Similarly, a C₁-C₁₂ alkyl includes all the foregoing moieties, but also includes C₁₁ and C₁₂ alkyls. Non-limiting examples of C₁-C₁₂ alkyl include methyl, ethyl, n-propyl, i-propyl, n-butyl, i-butyl, sec-butyl, t-butyl, n-pentyl, t-amyl, n-hexyl, n-heptyl, n-octyl, n-nonyl, n-decyl, n-undecyl, and n-dodecyl. Non-limiting examples of straight alkyl chain include methyl, ethyl, n-propyl, n-butyl, n-pentyl, n-hexyl, n-heptyl, and n-octyl. Non-limiting examples of branched alkyl chain include i-propyl, i-butyl, sec-butyl, t-butyl, sec-pentyl, i-pentyl, and t-amyl. Unless stated otherwise specifically in the specification, an alkyl group can be optionally substituted.

The term “Alkenyl” or “alkenyl group” refers to a straight or branched hydrocarbon chain radical having from two to twelve carbon atoms, and having one or more carbon-carbon double bonds. Each alkenyl group is attached to the rest of the molecule by a single bond. Alkenyl group comprising any number of carbon atoms from 2 to 25 are included. An alkenyl group comprising up to 25 carbon atoms is a C₂-C₂₅ alkenyl, an alkenyl comprising up to 10 carbon atoms is a C₂-C₁₀ alkenyl, an alkenyl group comprising up to 6 carbon atoms is a C₂-C₆ alkenyl, and an alkenyl comprising up to 5 carbon atoms is a C₂-C₅ alkenyl. A C₂-C₅ alkenyl includes C₅ alkenyls, C₄ alkenyls, C₃ alkenyls, and C₂ alkenyls. A C₂-C₆ alkenyl includes all moieties described above for C₂-C₅ alkenyls but also includes C₆ alkenyls. A C₂-C₁₀ alkenyl includes all moieties described above for C₂-C₅ alkenyls and C₂-C₆ alkenyls, but also includes C₇, C₈, C₉ and C₁₀ alkenyls. Similarly, a C₂-C₁₂ alkenyl includes all the foregoing moieties, but also includes C₁₁ and C₁₂ alkenyls. Non-limiting examples of C₂-C₁₂ alkenyl include ethenyl (vinyl), 1-propenyl, 2-propenyl (allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. Unless stated otherwise specifically in the specification, an alkenyl group can be optionally substituted.

The term “alkynyl” or “alkynyl group” refers to a straight or branched hydrocarbon chain radical having from 2 to 25 carbon atoms, and having one or more carbon-carbon triple bonds. Each alkynyl group is attached to the rest of the molecule by a single bond. Alkynyl group comprising any number of carbon atoms from 2 to 25 are included. An alkynyl group comprising up to 25 carbon atoms is a C₂-C₂₅ alkynyl, an alkynyl comprising up to 10 carbon atoms is a C₂-C₁₀ alkynyl, an alkynyl group comprising up to 6 carbon atoms is a C₂-C₆ alkynyl and an alkynyl comprising up to 5 carbon atoms is a C₂-C₅ alkynyl. A C₂-C₅ alkynyl includes C₅ alkynyls, C₄ alkynyls, C₃ alkynyls, and C₂ alkynyls. A C₂-C₆ alkynyl includes all moieties described above for C₂-C₅ alkynyls but also includes C₆ alkynyls. A C₂-C₁₀ alkynyl includes all moieties described above for C₂-C₅ alkynyls and C₂-C₆ alkynyls, but also includes C₇, C₈, C₉ and C₁₀ alkynyls. Similarly, a C₂-C₁₂ alkynyl includes all the foregoing moieties, but also includes C₁₁ and C₁₂ alkynyls. Non-limiting examples of C₂-C₂₅ alkynyl include ethynyl, propynyl, butynyl, pentynyl and the like. Unless stated otherwise specifically in the specification, an alkynyl group can be optionally substituted.

The term “cycloalkyl” refers to a stable non-aromatic monocyclic or polycyclic fully saturated hydrocarbon radical consisting solely of carbon and hydrogen atoms, which can include fused, bridged, or spiro ring systems, having from three to twenty carbon atoms, e.g., having from three to ten carbon atoms, and which is attached to the rest of the molecule by a single bond. Monocyclic cycloalkyl radicals include, for example, cyclopropyl, cyclobutyl, cyclopentyl, cyclohexyl, cycloheptyl, and cyclooctyl. Polycyclic cycloalkyl radicals include, for example, adamantyl, norbornyl, decalinyl, 7,7-dimethyl-bicyclo[2.2.1]heptanyl, and the like. Unless otherwise stated specifically in the specification, a cycloalkyl group can be optionally substituted.

The term “aryl” refers to a hydrocarbon ring system radical comprising hydrogen, 6 to 18 carbon ring atoms and at least one aromatic ring. For purposes of this disclosure, the aryl radical can be a monocyclic, bicyclic, tricyclic or tetracyclic ring system, which can include fused, bridged, or spiro ring systems. Aryl radicals include, but are not limited to, aryl radicals derived from aceanthrylene, acenaphthylene, acephenanthrylene, anthracene, azulene, benzene, chrysene, fluoranthene, fluorene, as-indacene, s-indacene, indane, indene, naphthalene, phenalene, phenanthrene, pleiadene, pyrene, and triphenylene. Unless stated otherwise specifically in the specification, the term “aryl” is meant to include aryl radicals that are optionally substituted.

The term “substituted” used herein means any of the groups described herein (e.g., alkyl, alkenyl, alkynyl, alkoxy, aryl, aralkyl, carbocyclyl, cycloalkyl, cycloalkenyl, cycloalkynyl, haloalkyl, heterocyclyl, and/or heteroaryl) wherein at least one hydrogen atom is replaced by a bond to a non-hydrogen atoms such as, but not limited to: a halogen atom such as F, Cl, Br, and I; an oxygen atom in groups such as hydroxyl groups, alkoxy groups, and ester groups; a sulfur atom in groups such as thiol groups, thioalkyl groups, sulfone groups, sulfonyl groups, and sulfoxide groups; a nitrogen atom in groups such as amines, amides, alkylamines, dialkylamines, arylamines, alkylarylamines, diarylamines, N-oxides, imides, and enamines; a silicon atom in groups such as trialkylsilyl groups, dialkylarylsilyl groups, alkyldiarylsilyl groups, and triarylsilyl groups; and other heteroatoms in various other groups. “Substituted” also means any of the above groups in which one or more hydrogen atoms are replaced by a higher-order bond (e.g., a double- or triple-bond) to a heteroatom such as oxygen in oxo, carbonyl, carboxyl, and ester groups; and nitrogen in groups such as imines, oximes, hydrazones, and nitriles. For example, “substituted” includes any of the above groups in which one or more hydrogen atoms are replaced with —NR_{g}Rₕ, —NR_{g}C(═O)Rₕ, —NR_{g}C(═O)NR_{g}Rₕ, —NR_{g}C(═O)ORₕ, —NR_{g}SO₂Rₕ, —OC(═O)NR_{g}Rₕ, —OR_{g}, —SR_{g}, —SOR_{g}, —SO₂R_{g}, —OSO₂R_{g}, —SO₂OR_{g}, =NSO₂R_{g}, and —SO₂NR_{g}Rₕ. “Substituted” also means any of the above groups in which one or more hydrogen atoms are replaced with —C(═O)R_{g}, —C(═O)OR_{g}, —C(═O)NR_{g}Rₕ, —CH₂SO₂R_{g}, —CH₂SO₂NR_{g}Rₕ. In the foregoing, R_{g} and Rₕ are the same or different and independently hydrogen, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl. “Substituted” further means any of the above groups in which one or more hydrogen atoms are replaced by a bond to an amino, cyano, hydroxyl, imino, nitro, oxo, thioxo, halo, alkyl, alkenyl, alkynyl, alkoxy, alkylamino, thioalkyl, aryl, aralkyl, cycloalkyl, cycloalkenyl, cycloalkynyl, cycloalkylalkyl, haloalkyl, haloalkenyl, haloalkynyl, heterocyclyl, N-heterocyclyl, heterocyclylalkyl, heteroaryl, N-heteroaryl and/or heteroarylalkyl group. In addition, each of the foregoing substituents can also be optionally substituted with one or more of the above substituents.

It is further noted that the claims may be drafted to exclude any optional element. As such, this statement is intended to serve as antecedent basis for use of such exclusive terminology as “solely”, “only” and the like in connection with the recitation of claim elements, or the use of a “negative” limitation.

### Methods

In one aspect, the present disclosure provides methods of scalable manufacture of psilocybin and a crystalline form of psilocybin (e.g., “Anhydrate Form A”) from psilocin, 4-acetoxyindole, or 4-hydroxyindole. In particular, the present disclosure provides a method of preparing psilocybin from psilocin and tetrabenzylpyrophosphate (TBPP) in the presence of a lithium chloride complex Grignard reagent. Embodiments of the method are described below. “Stage” refers to a conversion of starting material to product, and the conversion may involve multiple steps, as discussed below.

In embodiments, the method comprises:
Stage 3: step (i) mixing psilocin and tetrabenzylpyrophosphate (TBPP) in the presence of a Grignard reagent to form a reaction mixture; and step (ii) subjecting the reaction mixture to hydrogen in the presence of a catalyst to form psilocybin, wherein the Grignard reagent is a lithium chloride complex Grignard reagent of Formula (I)

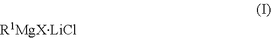

wherein:
R¹ is optionally substituted C₁-C₁₂ alkyl, optionally substituted C₂-C₁₂ alkenyl, optionally substituted C₂-C₁₂ alkynyl, optionally substituted C₃-C₉ cycloalkyl, or optionally substituted C₆-C₁₈ aryl; and
X is Cl, Br, or I.

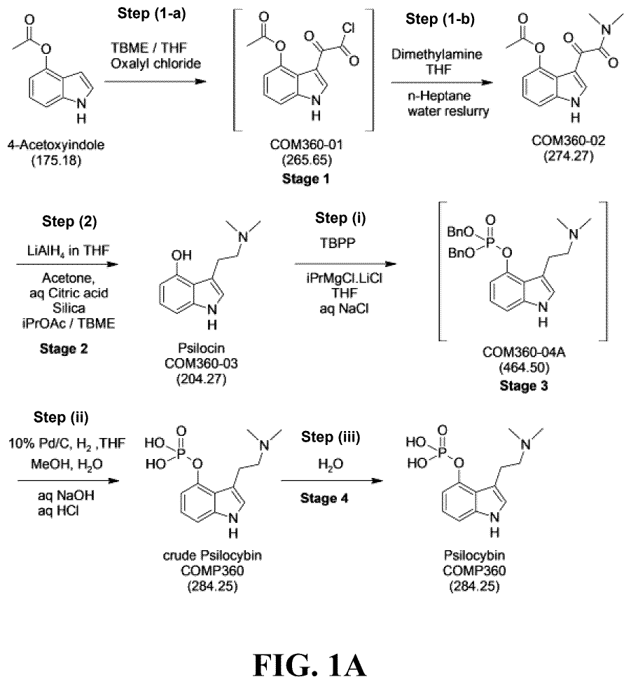

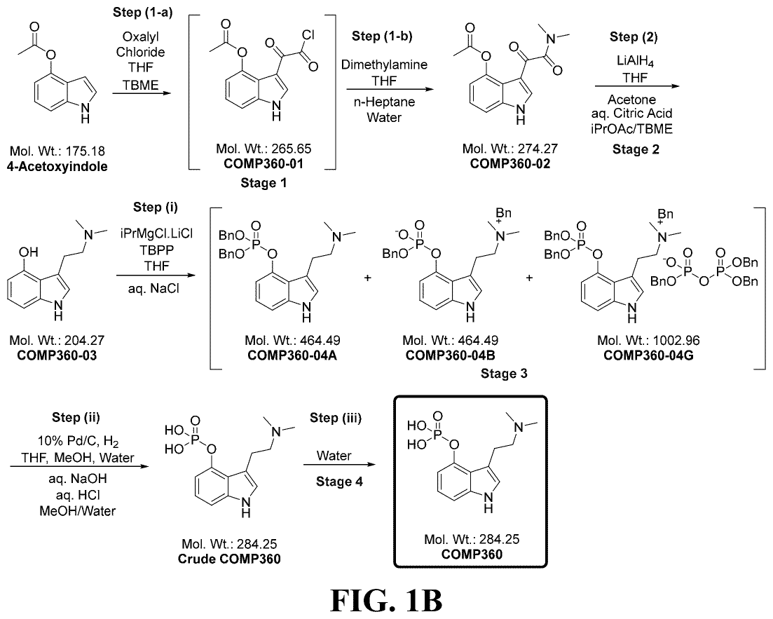

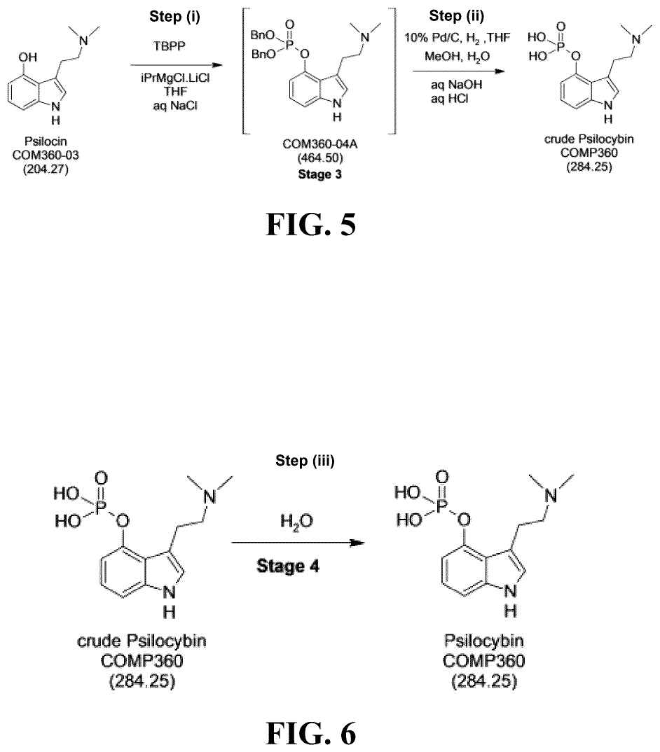

As used herein, Stage 3 and steps (i)-(ii) can be used interchangeably (see FIGS. 1 and 5).

In embodiments, the method further comprises:
Stage 4: step (iii) crystallizing the psilocybin from water, thereby forming a crystalline form of psilocybin.

As used herein, Stage 4 and step (iii) can be used interchangeably (see FIGS. 1 and 6).

In embodiments, psilocin of Stage 3 is prepared by a method comprising:
Stage 1: mixing 1H-indol-4-yl acetate (i.e., 4-acetoxyindole) and oxalyl chloride (step (1-a)) and dimethylamine to (step (1-b)) form 3-[(dimethylcarbamoyl)carbonyl]-1H-indol-4yl-acetate; and
Stage 2: step (2) mixing 3-[(dimethylcarbamoyl)carbonyl]-1H-indol-4yl-acetate and lithium aluminium hydride to form psilocin.

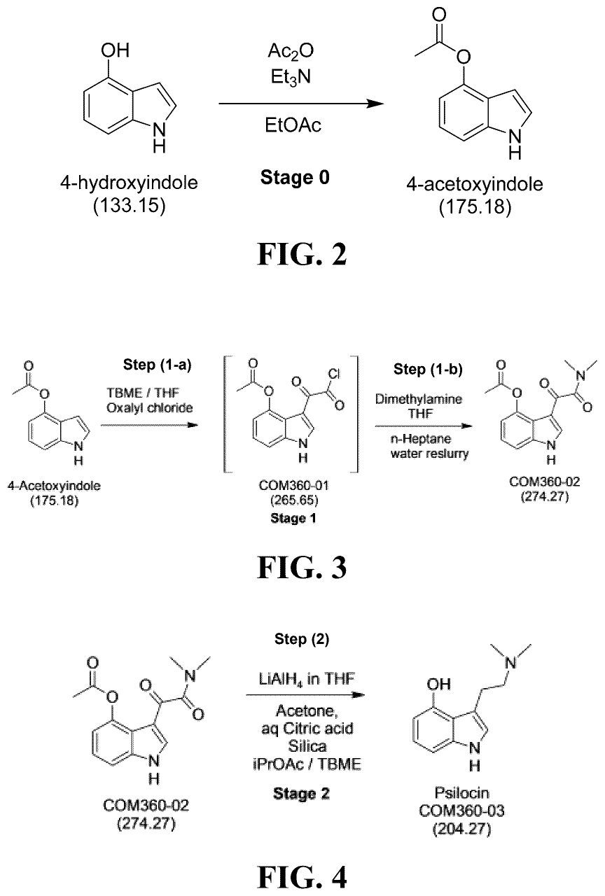

As used herein, Stage 1 and steps (1-a)-(1-b) can be used interchangeably (see FIGS. 1 and 3). Stage 2 and step (2) can be used interchangeably (see FIGS. 1 and 4).

In embodiments, 1H-indol-4-yl acetate of Stage 1 is prepared by a method comprising: Stage 0: reacting 4-hydroxyindole with acetic anhydride to form 1H-indol-4-yl acetate.

### Stage 0

In embodiments, the present disclosure further provides methods of preparing 1H-indol-4-yl acetate from 4-hydroxyindole (Stage 0; FIG. 2).

The core reaction of Stage 0 is the reaction of 4-hydroxyindole with acetic anhydride to form 1H-indol-4-yl acetate. In embodiments, Stage 0 comprises mixing 4-hydroxyindole with acetic anhydride in the optional presence of triethylamine and/or pyridine to form 1H-indol-4-yl acetate. In embodiments, ethyl acetate is used as the solvent. In embodiments, DCM is used as the solvent.

A non-limiting example of Stage 0 is as follows: 4-hydroxyindole, EtOAc, and triethylamine are added to a vessel and stirred at about 5-35° C. (e.g., 25° C.±5° C.). Acetic anhydride is added dropwise, and the Stage 0 mixture is stirred at about 20-30° C. or about 20-25° C. and stirred until complete by HPLC. The Stage 0 mixture is washed with aqueous citric acid solution and aqueous K₂CO₃, dried over MgSO₄, filtered and evaporated to approximately half volume. n-Heptane is added, and distillation continued to remove the solvent. The mixture is cooled to about 5-25° C., filtered, washed with n-heptane and dried in a vacuum oven overnight to isolate 1H-indol-4-yl acetate (as a solid suitable for use in the following stage).

Stage 1 (Steps (1-a), (1-b)) & Stage 2 (Step 2)

In embodiments, the present disclosure further provides methods of preparing psilocin from 1H-indol-4-yl acetate (4-acetoxyindole), which can be prepared from 4-hydroxyindole.

In embodiments, the psilocin is manufactured by a method comprising: (1) reacting 1H-indol-4-yl acetate with oxalyl chloride and dimethylamine to form 3-([(dimethylcarbamoyl)carbonyl])-1H-indol-4-yl acetate (Stage 1 (Steps 1-a, 1-b); FIG. 3); and (2) reacting 3-([(dimethylcarbamoyl)carbonyl)-1H-indol-4-yl acetate with lithium aluminum hydride to form psilocin (Stage 2 (Step 2); FIG. 4).

In embodiments, step (1) comprises: (1-a) reacting 1H-indol-4-yl acetate (i.e., 4-acetoxyindole) with oxalyl chloride to form 3-(2-chloro-2-oxoacetyl)-1H-indol-4-yl acetate (COM360-01); and (1-b) reacting the 3-(2-chloro-2-oxoacetyl)-1H-indol-4-yl acetate with dimethylamine to form 3-([(dimethylcarbamoyl)carbonyl])-1H-indol-4-yl acetate (COM360-02) (i.e., Stage 1). In embodiments, the reacting in step (1-a) is conducted in a mixture of tert-butyl methyl ether (TBME) and THF. In embodiments, the reacting in step (1-a) is conducted at a temperature from about 25° C. to about 47° C., from about 30° C. to about 40° C., from about 32° C. to about 38° C., or at about 36° C. In embodiments, the reacting in step (1-a) is performed for about 0.5 hour to about 4 hours, about 1 hour to about 3 hours, about 1.5 hours to about 2.5 hours, or about 2 hours. In embodiments, the reacting in step (1-a) comprises: adding oxalyl chloride to a mixture of TBME and THF at a temperature of about 15-25° C. to form a mixture comprising oxalyl chloride; increasing the temperature of the mixture comprising oxalyl chloride to about 25-47° C.; adding a mixture of 4-acetoxyindole, TBME and THF to the mixture comprising oxalyl chloride at a temperature of about 31-41° C. over a period of about 20-54 minutes to form a reaction mixture; and stirring the reaction for about 1.5-2.5 hours. In embodiments, dimethylamine is used in excess in step (1-b). In embodiments, in step (1-b) dimethylamine is reacted with the 3-(2-chloro-2-oxoacetyl)-1H-indol-4-yl acetate at a temperature of about −4° C. to about 15° C., or about −1° C. to about 9° C. In embodiments, in step (1-b) dimethylamine is reacted with the 3-(2-chloro-2-oxoacetyl)-1H-indol-4-yl acetate for about 0.5 hour to about 4 hours, about 1 hour to about 3 hours, about 1.5 hours to about 2.5 hours, or about 2 hours.

A non-limiting example of Stage 1 is as follows: 1H-indol-4-yl acetate is dissolved in a mixture of THF and TBME at room temperature (15-25° C.). Oxalyl chloride is added dropwise allowing the reaction to exotherm at about 25-47° C., about 35-40° C., or about 36° C. The temperature range is maintained throughout the remainder of the addition. The reaction is then stirred at about 31-41° C., about 35-40° C., or about 36° C. for about 1-4 hours, about 1.5-2.5 hours, or about 2 hours, or until complete as shown by HPLC. The reaction is cooled to about −4 to 15° C., about −1 to 9° C., or about 4° C. Dimethylamine solution is added, and the temperature is maintained at about −4 to 15° C., about −1 to 9° C., or about 4° C. The reaction was filtered, washed with THF and TBME, and dried in a vacuum oven. The crude 3-([(dimethylcarbamoyl)carbonyl])-1H-indol-4-yl acetate can be further purified by a slurry in water, then IPA and then dried in a vacuum oven to yield as a solid suitable for use in the following stage.

A non-limiting example of Stage 2 is as follows: The 3-([(dimethylcarbamoyl)carbonyl])-1H-indol-4-yl acetate (COM360-02) is slurried in THF and cooled to about 9-19° C. or about 0-10° C. (i.e., step 2). A THF solution of LiAlH₄ is added dropwise while maintaining the temperature at about 0-20° C., 9-19° C., or about 14° C. The reaction is then refluxed until complete by HPLC. The reaction is cooled to 0-10° C., and the excess LiAlH₄ is quenched by addition of acetone followed by aqueous citric acid solution. The batch is filtered to remove lithium and aluminum salts. The filtrate is dried over MgSO₄, filtered, and concentrated and loaded onto a silica pad. The pad was eluted with THF and the product containing fractions evaporated. The resulting solid is slurried in iPrOAc:TBME mixture, filtered and washed with TBME. The solid is dried in vacuo to yield psilocin as an off white solid.

A further example of Stage 2 is as follows: The 3-([(dimethylcarbamoyl)carbonyl])-1H-indol-4-yl acetate (COM360-02) is slurried in THF and cooled to about 9-19° C. (i.e., step 2). A THF solution of LiAlH₄ is added dropwise while maintaining the temperature at about 0-20° C., about 9-19° C., or about 14° C. The reaction is then stirred at about 10-30° C. or about 15-25° C. for about 30-60 minutes, followed by at about 50-70° C., 53-66° C., or 53-63° C. for at least 8 hours, at least 12 hours, at least 24 hours, or until completion, as determined by e.g., IPC (in-process control). The reaction is cooled to 0-10° C., and the excess LiAlH₄ is quenched by addition of acetone followed by aqueous citric acid solution. The mixture is stirred for at least 1 h at 15-25° C., then filtered under nitrogen. The filter cake is washed with THF. The filter cake is slurried with a mixture of THF and water at 15-25° C. for at least 2 hours. The batch is filtered under nitrogen and the filter cake is washed with THF. The filtrate is concentrated. The resulting solid is slurried in iPrOAc:TBME mixture, filtered and washed with TBME. The solid is further purified by a slurry in water. The solid is collected and dried in vacuo at about 40° C. to yield psilocin.

Stage 3 (Step (i)-(ii))

In embodiments, the present disclosure provides methods of manufacturing psilocybin from psilocin (Stage 3, steps (i) and (ii); FIG. 5). The method comprises: (i) mixing psilocin and tetrabenzylpyrophosphate (TBPP) in the presence of a Grignard reagent to form a reaction mixture; and (ii) subjecting the reaction mixture to hydrogen in the presence of a catalyst to form psilocybin. In embodiments, the Grignard reagent is a lithium chloride complex Grignard reagent of Formula (I)

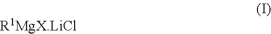

wherein:
R¹ is optionally substituted C₁-C₁₂ alkyl, optionally substituted C₂-C₁₂ alkenyl, optionally substituted C₂-C₁₂ alkynyl, optionally substituted C₃-C₉ cycloalkyl, or optionally substituted C₆-C₁₈ aryl; and X is Cl, Br, or I.

In embodiments, R¹ is optionally substituted C₁-C₁₂ alkyl, optionally substituted C₂-C₁₁ alkyl, optionally substituted C₃-C₁₀ alkyl, optionally substituted C₄-C₉ alkyl, optionally substituted C₅-C₈ alkyl, or optionally substituted C₆₋₇ alkyl. In embodiments, R¹ is optionally substituted C₁-C₄ alkyl, or C₂-C₃ alkyl. In embodiments, R¹ has a straight alkyl chain. In embodiments, R¹ has a branched alkyl chain. In embodiments, R¹ is methyl, ethyl, n-propyl, i-propyl, n-butyl, i-butyl, sec-butyl, t-butyl, n-pentyl, t-amyl, n-hexyl, n-heptyl, n-octyl, or n-nonyl. In embodiments, R¹ is methyl, ethyl, n-propyl, isopropyl, n-butyl, isobutyl, sec-butyl, or tert-butyl. In embodiments, R¹ is isopropyl, sec-butyl, or tert-butyl. In embodiments, R¹ is isopropyl.

In embodiments, R¹ is optionally substituted C₂-C₁₂ alkenyl, optionally substituted C₃-C₁₁ alkenyl, optionally substituted C₄-C₁₀ alkenyl, optionally substituted C₅-C₉ alkenyl, optionally substituted C₆-C₈ alkenyl, or optionally substituted C₇ alkenyl. In embodiments, R¹ is optionally substituted C₂-C₁₂ alkynyl, optionally substituted C₃-C₁₁ alkynyl, optionally substituted C₄-C₁₀ alkynyl, optionally substituted C₅-C₉ alkynyl, optionally substituted C₆-C₈ alkynyl, or optionally substituted C₇ alkynyl. In embodiments, R¹ is optionally substituted C₃-C₉ cycloalkyl, optionally substituted C₄-C₈ cycloalkyl, optionally substituted C₅-C₇ cycloalkyl, or optionally substituted C₆ cycloalkyl. In embodiments, R¹ is optionally substituted C₆-C₁₈ aryl, including phenyl, naphthyl, or anthracenyl.

In embodiments, X is Cl or Br. In embodiments, X is Cl.

In embodiments, R¹ is isopropyl, sec-butyl, or tert-butyl. In embodiments, X is Cl. In embodiments, the Grignard reagent is isopropylmagnesium chloride lithium chloride complex ((CH₃)₂CHMgCl·LiCl), tert-butylmagnesium chloride lithium chloride complex ((CH₃)₃CMgCl·LiCl) or sec-butylmagnesium chloride lithium chloride complex ((CH₃)(CH₂CH₃)CHMgCl·LiCl). In embodiments, the Grignard reagent is isopropylmagnesium chloride lithium chloride complex ((CH₃)₂CHMgCl·LiCl).

In embodiments, the mixing in step (i) of Stage 3 is performed in an organic solvent. Exemplary organic solvents include, but are not limited to, ethers (e.g. diethyl ether, tetrahydrofuran, 1,4-dioxane, tetrahydropyran, t-butyl methyl ether, cyclopentyl methyl ether, di-isopropyl ether), aromatic solvents (e.g., benzene, ethylbenzene, o-xylene, m-xylene, p-xylene, and mixtures of xylenes, toluene, mesitylene, anisole, 1,2-dimethoxybenzene, α,α,α,-trifluoromethylbenzene, fluorobenzene, heavy aromatic naptha), alkane solvents (e.g., pentane, cyclopentane, hexanes, cyclohexane, heptanes, cycloheptane, octanes), glycol ethers (e.g. 1,2-dimethoxyethane, diglyme, triglyme), chlorinated solvents (e.g. chlorobenzene, dichloromethane, 1,2-dichloroethane, 1,1-dichloroethane, chloroform, carbon tetrachloride), ester solvents (e.g. ethyl acetate, propyl acetate), ketones (e.g. acetone, butanone), formamides/acetamides (e.g., formamide, dimethyl formamide, dimethyl acetamide), as well as mixtures thereof in suitable proportions. In embodiments, the organic solvent is an ether. In embodiments, the organic solvent is THF, diethyl ether, or mixtures thereof. In embodiments, the organic solvent is THF.

In embodiments, the mixing in step (i) of Stage 3 is performed at a temperature greater than −60° C., greater than −50° C., greater than −40° C., greater than −30° C., greater than −20° C., greater than −10° C., greater than −4° C., or greater than 0° C. In embodiments, the mixing in step (i) is performed at a temperature from about −10° C. to about 25° C., from about −6° C. to about 20° C., from about −4° C. to about 15° C., from about 0° C. to about 13° C., from about 1° C. to about 11° C., from about 4° C. to about 8° C., or about 6° C. In embodiments, the mixing in step (i) is performed at a temperature from about 1° C. to about 11° C., from about 3° C. to about 9° C., from about 5° C. to about 7° C., or about 6° C. In embodiments, the mixing in step (i) of the method is performed for up to 4 hours, up to 3 hours, up to 2 hours, up to 1 hour, or up to 0.5 hours. In embodiments, the mixing in step (i) is performed for 0.1 hours to 3 hours, 0.5 hours to 2 hours, or 1 hour to 1.5 hours.

In embodiments, the mixing in step (i) of Stage 3 comprises: (i-1) mixing psilocin and the Grignard reagent to form a first mixture; and (i-2) mixing TBPP with the first mixture to form the reaction mixture.

In embodiments, the first mixture in (i-1) is formed by mixing psilocin and the Grignard reagent at a temperature greater than −60° C., greater than −50° C., greater than −40° C., greater than −30° C., greater than −20° C., greater than −10° C., greater than −4° C., or greater than 0° C. for up to 2 hours, up to 1 hour, or up to 0.5 hours. In embodiments, the first mixture is formed by mixing psilocin and the Grignard reagent at a temperature from about −10° C. to about 25° C., from about −6° C. to about 20° C., from about −4° C. to about 15° C., from about 0° C. to about 13° C., from about 1° C. to about 11° C., from about 4° C. to about 8° C., or about 6° C. for up to 2 hours, up to 1 hour, or up to 0.5 hours. In embodiments, the first mixture is formed by mixing psilocin and the Grignard reagent at a temperature from about 1° C. to about 11° C., from about 3° C. to about 9° C., from about 5° C. to about 7° C., or about 6° C. for 0.5 hours to 1 hour, 5 minutes to 25 minutes, 10 minutes to 20 minutes, or about 15 minutes.

In embodiments, the reaction mixture in (i-2) is formed by mixing TBPP with the first mixture at a temperature greater than −60° C., greater than −50° C., greater than −40° C., greater than −30° C., greater than −20° C., greater than −10° C., greater than −4° C., or greater than 0° C. for up to 2 hours, up to 1 hour, or up to 0.5 hours. In embodiments, the reaction mixture is formed by mixing TBPP with the first mixture at a temperature from about −10° C. to about 25° C., from about −6° C. to about 20° C., from about −4° C. to about 15° C., from about 0° C. to about 13° C., from about 1° C. to about 11° C., from about 4° C. to about 8° C., or about 6° C. for up to 2 hours, up to 1 hour, or up to 0.5 hours. In embodiments, the reaction mixture is formed by mixing TBPP with the first mixture at a temperature from about 1° C. to about 11° C., from about 3° C. to about 9° C., from about 5° C. to about 7° C., or about 6° C. for 0.5 hours to 1 hour, 5 minutes to 25 minutes, 10 minutes to 20 minutes, or about 15 minutes.

The mixtures described herein (e.g., reaction mixture, the first mixture) may be agitated via methods known to those of ordinary skill in the art, e.g., using an agitator, a vortexer, a rotary shaker, a magnetic stirrer, a centrifugal mixer, an overhead stirrer.

In embodiments, a molar ratio of the Grignard reagent to psilocin ranges from about 1:1 to about 2:1, from about 1.05:1 to about 1.8:1, from about 1.1:1 to about 1.6:1, from about 1.2:1 to about 1.4:1, or about 1.3:1. In embodiments, a molar ratio of the Grignard reagent to psilocin ranges from 1.1:1 to 1.4:1, or 1.15:1 to 1.3:1. In embodiments, a molar ratio of the TBPP to psilocin ranges from about 1:1 to about 3:1, from about 1.1:1 to about 2.5:1, from about 1.2:1 to about 2:1, from about 1.3:1 to about 1.6:1, or from about 1.4:1 to about 1.5:1. In embodiments, a molar ratio of the TBPP to psilocin ranges from 1.2:1 to 1.5:1, from 1.3:1 to 1.41:1, or from 1.3:1 to 1.4:1.

In embodiments, step (i) of Stage 3 further comprises quenching the reaction mixture with water or an aqueous solution (aqueous work-up) prior to step (ii). Exemplary aqueous solutions include, but are limited to, aqueous NaCl solution, aqueous NaHCO₃ solution, and aqueous NH₄Cl solution. In embodiments, the quenching prior to step (ii) comprises: (i-3) mixing the reaction mixture of step (i) with a water or an aqueous solution at a temperature below 30° C., below 25° C., or below 20° C. for less than 1 hour, less than 45 minutes, less than 30 minutes, or less than 15 minutes to form an aqueous layer and an organic layer; and (i-4) collecting the reaction mixture which is present in the organic layer.

As used herein, the names for compounds starting with “COM360” (e.g., COM360-01) are used interchangeably with names starting with “COMP360” (e.g., COMP360-01). For example, both “COM360-03” and “COMP360-03” refer to psilocin. Both “COM360-04A” and “COMP360-04A” refer to

The reaction of psilocin and TBPP with other bases (e.g., NaHMDS) often forms benzyl 3-[2-(benzyldimethylazaniumyl)ethyl]-1H-indol-4-yl phosphate (COM360-04B) as an intermediate, which must be isolated before proceeding to the subsequent hydrogenation step. In contrast, the reaction of psilocin and TBPP in the presence of the Turbo Grignard reagent unexpectedly forms COM360-04A (also known as “COMP360-04A”) as the major intermediate, which could be converted directly to psilocybin under hydrogenation. Therefore, no additional isolation of impurities such as COM360-04B (also known as “COMP360-04B”) or COM360-04G (also known as “COMP360-04G”) is needed, providing a clean and efficient product formation. The structures of COM360-04A, COM360-04B, and COM360-04G are shown below:

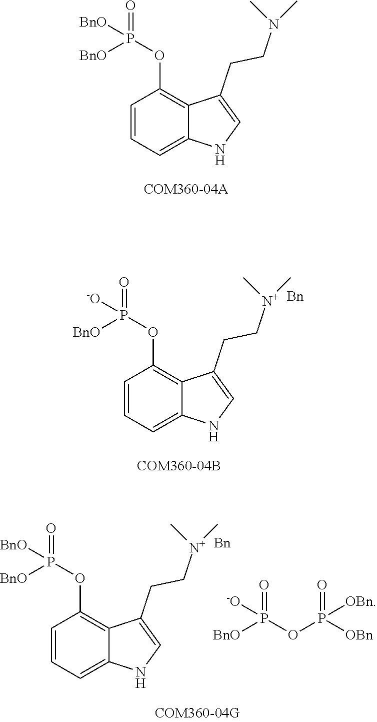

As used herein, the names for compounds starting with “COM360-” (e.g., COM360-01) are used interchangeably with those having names starting with “COMP360-” (e.g., COMP360-01). For example, both “COM360-03” and “COMP360-03” refer to psilocin. Both “COM360-04A” and “COMP360-04A” refer to

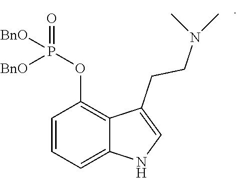 [SMILES: CN(C)CCc1c[nH]c2cccc(OP(=O)(OCc3ccccc3)OCc3ccccc3)c12]

In embodiments, the yield of psilocybin from psilocin is about 40% or greater, about 50% or greater, about 55% or greater, about 60% or greater, about 70% or greater, or about 80% or greater. In embodiments, the yield of psilocybin from 1H-indol-4-yl acetate is about 20% or greater, about 25% or greater, about 28% or greater, about 30% or greater, about 35% or greater, or about 40% or greater

In embodiments, benzyl 3-[2-(benzyldimethylazaniumyl)ethyl]-1H-indol-4-yl phosphate (COM360-04B) is not isolated in the method described herein.

Step (ii) of Stage 3 comprises subjecting the reaction mixture to hydrogen in the presence of a catalyst to form psilocybin. In embodiments, the catalyst in step (ii) is a palladium on carbon (Pd/C) catalyst. As shown in FIG. 5, the core reaction comprises reacting the reaction mixture with hydrogen to form psilocybin.

In embodiments, the reaction mixture is subjected to hydrogen in the presence of Pd/C catalyst (e.g., 10% Pd/C) using water and ethanol as solvent at a temperature of about 20° C. to about 60° C., about 30° C. to about 55° C., about 40° C. to about 50° C. for up to 2 days, up to 24 hours, or up to 12 hours, thereby forming psilocybin. In embodiments, the reaction mixture is subjected to hydrogen in the presence of Pd/C catalyst (e.g., 10% Pd/C) using water as solvent at a temperature of about 10° C. to about 60° C., about 15° C. to about 55° C., about 20° C. to about 50° C., or about 15° C. to about 25° C., for at least 2 days, at least 24 hours, at least 16 hours, or at least 12 hours, thereby forming psilocybin. In embodiments, aqueous NaOH and/or aqueous HCl are used to adjust pH of the reaction mixture after hydrogenation.

Stage 4 (Step (iii))

In embodiments, the method further comprises (iii) crystallizing the psilocybin from water, thereby forming a crystalline form of psilocybin (Stage 4, step (iii); FIG. 6).

In embodiments, the crystallizing in step (iii) of the method comprises: combining the crude psilocybin and about 10-20 volumes of water to form an aqueous mixture; heating the aqueous mixture with agitation to a temperature of at least 70° C., e.g., 70-80° C., to provide a solution; filtering the solution to form a filtered solution; seeding the filtered solution at a temperature of about 70° C., e.g., 68-70° C., or 61-67° C., under optional stirring for about 2 hours, to form a seeded suspension; cooling the seeded suspension to a temperature of about 15-25° C. over a period of more than 12 hours, or about 12 hours to about 24 hours, then cooling the seeded suspension to a temperature of about 0-10° C. or about 0-5° C. over a period of more than 1 hour or more than 2 hours to form a cooled suspension; filtering the cooled suspension to form a solid; and drying the solid, e.g., in vacuo at a temperature from about 30° C. to about 70° C., from about 40° C. to about 60° C., or about 60° C., thereby forming the crystalline form of psilocybin (Anhydrate Form A). In embodiments, the filtering is polish filtering. In embodiments, the seeding comprises adding crystalline hydrate of psilocybin to the filtered solution, wherein the crystalline hydrate of psilocybin (Hydrate Form A) is characterized by X-ray powder diffraction (XRPD) peaks at 8.9±0.2, 13.8±0.2, 19.4±0.2, 23.1±0.2, and 23.5±0.2 020. In embodiments, the variance at any of the forgoing peaks may be ±0.1. In embodiments, crystalline hydrate of psilocybin (Hydrate Form A) is characterized by XRPD peaks at 8.9±0.1, 13.8±0.1, 19.4±0.1, 23.1±0.1, and 23.5±0.1°2θ. In embodiments, the seeding comprises adding Anhydrate Form A of psilocybin (as detailed below) which is mixed with water to the filtered solution. Anhydrate Form A rapidly converts to the crystalline hydrate of psilocybin (Hydrate Form A) upon mixing with water.

### Crystalline Form of Psilocybin (Anhydrate Form a)

In embodiments, the yield of the crystalline form of psilocybin from psilocin obtained via the method disclosed herein is about 35% or greater, about 40% or greater, about 42% or greater, about 45% or greater, about 50% or greater, or about 60% or greater.

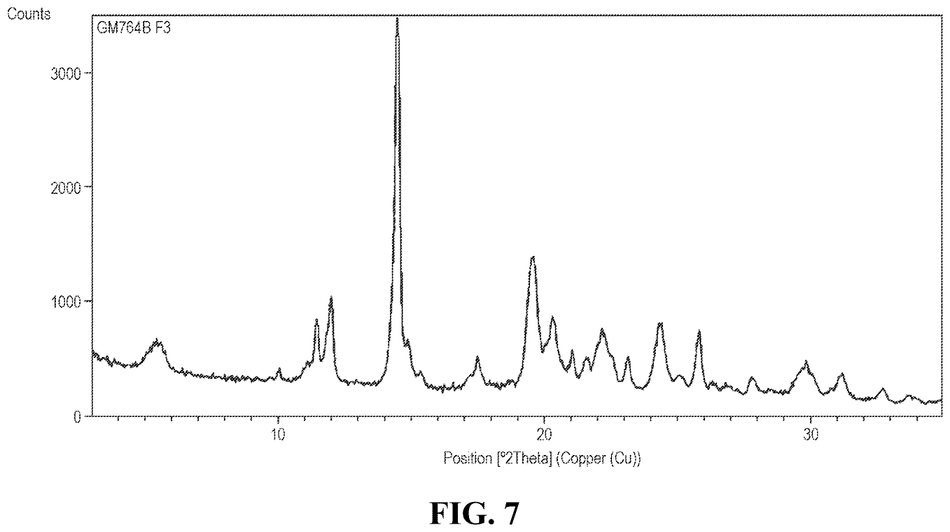

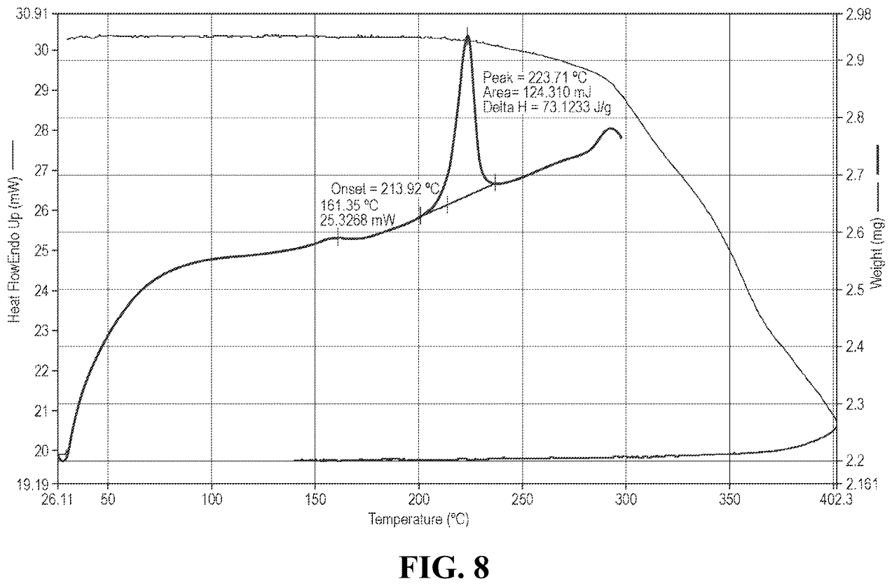

In embodiments, the crystalline form of psilocybin (Anhydrate Form A) is characterized by one or more of: (a) peaks in an XRPD diffractogram at 11.5, 12.0, 14.5, and 17.5, °2θ±0.2°2θ; (b) peaks in an XRPD diffractogram at 11.5, 12.0, 14.5 and 17.5, °2θ±0.2°2, further characterized by at least one additional peak at 19.7, 20.4, 22.2, 24.3 or 25.7°2θ±0.2°2θ; (c) an XRPD diffractogram as substantially illustrated in FIG. 7; or (d) an endothermic event in a DSC thermogram having an onset temperature of between 205 and 220° C. substantially as illustrated in FIG. 8. In embodiments, the variance at any of the forgoing peaks may be ±0.1. In embodiments, the crystalline form of psilocybin (Anhydrate Form A) is characterized by (a) peaks in an XRPD diffractogram at 11.5, 12.0, 14.5, and 17.5, °2θ±0.1°2θ; and/or (b) peaks in an XRPD diffractogram at 11.5, 12.0, 14.5 and 17.5, °2θ±0.1°2, further characterized by at least one additional peak at 19.7, 20.4, 22.2, 24.3 or 25.7°2θ±0.1°2θ.

In embodiments, the crystalline form of psilocybin described in the present method is characterized by XRPD peaks at 11.5±0.2, 12.0±0.2, 14.5±0.2, 17.5±0.2, and 19.7±0.2°2θ. In embodiments, the variance at any of the forgoing peaks may be ±0.1. In embodiments, the crystalline form of psilocybin described in the present method is characterized by XRPD peaks at 11.5±0.1, 12.0±0.1, 14.5±0.1, 17.5±0.1, and 19.7±0.1°2θ.

TABLE 1
XRPD peak positions for the crystalline
form of Psilocybin (Anhydrate Form A)

| Position [°2 Th.] | Relative Intensity [%] |
|---|---|
| 5.6 | 8.42 |
| 11.5 | 13.05 |
| 12.0 | 26.45 |
| 14.5 | 100 |
| 17.5 | 10.71 |
| 19.7 | 37.29 |
| 20.4 | 20.06 |
| 22.2 | 17.83 |
| 23.2 | 6.99 |
| 24.3 | 17.93 |
| 25.7 | 16.4 |
| 26.8 | 3.15 |
| 27.8 | 4.54 |
| 29.7 | 9.53 |
| 31.2 | 6.51 |
| 32.6 | 2.45 |
| 33.7 | 1.75 |

The peaks shown in Table 1 may have a variance of ±0.2°2θ or ±0.1°2θ.

In embodiments, the crystalline form of psilocybin exhibits an XRPD diffractogram characterized by the diffractogram summarized in Table 1. In one embodiment, the crystalline form of psilocybin comprises at least 3 peaks of (±0.1°2θ) of Table 1. In embodiments, the crystalline form of psilocybin comprises at least 4 peaks of (±0.1°2θ) of Table 1. In embodiments, the crystalline form of psilocybin comprises at least 5 peaks of (±0.1°2θ) of Table 1. In embodiments, the crystalline form of psilocybin comprises at least 6 peaks of (±0.1°2θ) of Table 1. In embodiments, the crystalline form of psilocybin comprises at least 8 peaks of (±0.1°2θ) of Table 1. In embodiments, the crystalline form of psilocybin comprises at least 10 peaks of (±0.1°2θ) of Table 1. In embodiments, the crystalline form of psilocybin comprises at least 15 peaks of (±0.1°2θ) of Table 1.

In embodiments, the crystalline form of psilocybin is characterized by XRPD diffractogram peaks at 11.5, 12.0, 14.5, and 17.5° 2θ±0.2°2θ. In embodiments, the crystalline form of psilocybin is further characterized by at least one additional peak appearing at 19.7, 20.4, 22.2, 24.3 or 25.7° 2θ±0.2°2θ. In embodiments, the crystalline form of psilocybin is further characterized by at least two additional peaks appearing at 19.7, 20.4, 22.2, 24.3 or 25.7° 2°±0.2°2θ. In embodiments, the crystalline form of psilocybin is further characterized by at least three additional peaks appearing at 19.7, 20.4, 22.2, 24.3 or 25.7° 2°±0.2°2θ. In embodiments, the variance at any of the forgoing peaks may be ±0.1. In embodiments, the crystalline form of psilocybin is characterized by XRPD diffractogram peaks at 11.5, 12.0, 14.5, and 17.5° 2θ±0.1°2θ. In embodiments, the crystalline form of psilocybin is further characterized by at least one additional peak appearing at 19.7, 20.4, 22.2, 24.3 or 25.7° 2θ±0.1°2θ. In embodiments, the crystalline form of psilocybin is further characterized by at least two additional peaks appearing at 19.7, 20.4, 22.2, 24.3 or 25.7° 2θ±0.1°2θ. In embodiments, the crystalline form of psilocybin is further characterized by at least three additional peaks appearing at 19.7, 20.4, 22.2, 24.3 or 25.7°2θ±0.1°2θ. In embodiments, the crystalline form of psilocybin exhibits an XRPD diffractogram substantially the same as the XRPD diffractogram shown in FIG. 7.

In embodiments, the crystalline form of psilocybin is absent or substantially absent of an XRPD diffractogram peaks at 10.1. The term “substantially absent” indicates that any XRPD diffractogram peaks at 10.1 is less than 5%, less than 4%, less than 3%, or less than 2% of the intensity of the peak at 14.5°2θ, such as less than 1%, or is not detectable in the XRPD diffractogram.

In embodiments, the crystalline form of psilocybin is characterized by an endothermic event in a DSC thermogram having an onset temperature of between 205 and 220° C., such as between 21° and 220° C., such as between 21° and 218° C., or such as between 21° and 216° C. In embodiments, the crystalline form of psilocybin is further characterized by an endothermic event in the DSC thermogram having an onset temperature of between 145 and 165° C., such as between 145 and 160° C., or such as between 145 and 155° C. In embodiments, the crystalline form of psilocybin is characterized by an endothermic event having an onset temperature of between 205 and 220° C., such as between 21° and 220° C., such as between 21° and 218° C., or such as between 210 and 216° C., and an endothermic event having an onset temperature of between 145 and 165° C., such as between 145 and 160° C., or such as between 145 and 155° C., in a DSC thermogram. In embodiments, the crystalline form of psilocybin exhibits a DSC thermogram substantially the same as the DSC thermogram in FIG. 8.

In embodiments, the crystalline form of psilocybin is characterized by having a water content of <0.5% w/w, such as <0.4% w/w, such as <0.3% w/w, such as <0.2% w/w, or such as <0.1% w/w. Methods to determine the water content of a compound, for example Karl Fischer Titration, are known to a person of ordinary skill in the art. In one embodiment, the crystalline form of psilocybin is characterized by having <0.5% w/w loss, such as <0.4% w/w, such as <0.3% w/w, such as <0.2% w/w, or such as <0.1% w/w loss, in the TGA thermogram between ambient temperature, such as about 25° C., and 200° C. In embodiments, the crystalline form of psilocybin loses less than 2% by weight in a loss on drying test, such as less than 1% by weight, such as less than 0.5% by weight. The loss on drying test is performed at 70° C. In embodiments, the crystalline form of psilocybin has a water content of less than 2% by weight as determined by Karl Fischer (KF) titration, such as less than 1% by weight, such as less than 0.5% by weight.

In embodiments, the crystalline form of psilocybin is a white to off white solid.

In embodiments, the crystalline form of psilocybin is chemically pure, for example the psilocybin has a chemical purity of greater than 97%, such as greater than 98%, or such as greater than 99% as determined by HPLC. In one embodiment, the crystalline form of psilocybin has no single impurity of greater than 1%, more preferably less than 0.5%, including phosphoric acid as measured by ³¹P NMR, and psilocin as measured by HPLC. In one embodiment, the crystalline form of psilocybin has a chemical purity of greater than 97 area %, more preferably still greater than 98 area %, and most preferably greater than 99 area % as determined by HPLC. In one embodiment, the crystalline form of psilocybin has no single impurity greater than 1 area %, more preferably less than 0.5 area % as measured by HPLC. In one embodiment, the crystalline form of psilocybin does not contain psilocin at a level greater than 1 area %, more preferably less than 0.5 area % as measured by HPLC. In one embodiment, the crystalline form of psilocybin does not contain psilocin at a level greater than 1 area % as measured by HPLC. In one embodiment, the crystalline form of psilocybin does not contain psilocin at a level greater than 0.5 area % as measured by HPLC. In one embodiment, the crystalline form of psilocybin does not contain phosphoric acid at a level greater than 1 weight %, more preferably less than 0.5 weight % as measured by ³¹P NMR. In one embodiment, the crystalline form of psilocybin has a chemical assay of at least 95 wt %, such as at least 96 wt %, or such as at least 98 wt %.

In embodiments, the psilocybin has a chemical purity of greater than 95%, greater than 97%, greater than 98%, or greater than 99% as determined by HPLC analysis. In embodiments, the psilocybin has a chemical purity of about 96%, about 97%, about 98%, about 99%, or about 99.9% as determined by HPLC analysis. In embodiments, the psilocybin has a chemical purity of at least 99.1%, 99.3%, 99.5% or 99.9% as determined by HPLC analysis. In embodiments, the psilocybin has a chemical purity of 99.5%, 99.6%, 99.7% or 99.8% as determined by HPLC analysis.

In embodiments, the method disclosed herein manufactures the crystalline form of psilocybin at a scale greater than 100 g, greater than 200 g, greater than 300 g, greater than 400 g, greater than 500 g, greater than 600 g, greater than 700 g, greater than 800 g, greater than 900 g, or greater than 1,000 g. In embodiments, the method manufactures the crystalline form of psilocybin at a scale of at least 500 g, at least 700 g, at least 800 g, at least 900 g, at least 1,000 g, at least 1,200 g, or at least 1,500 g.

### Crystalline Hydrate of Psilocybin (Hydrate Form A)

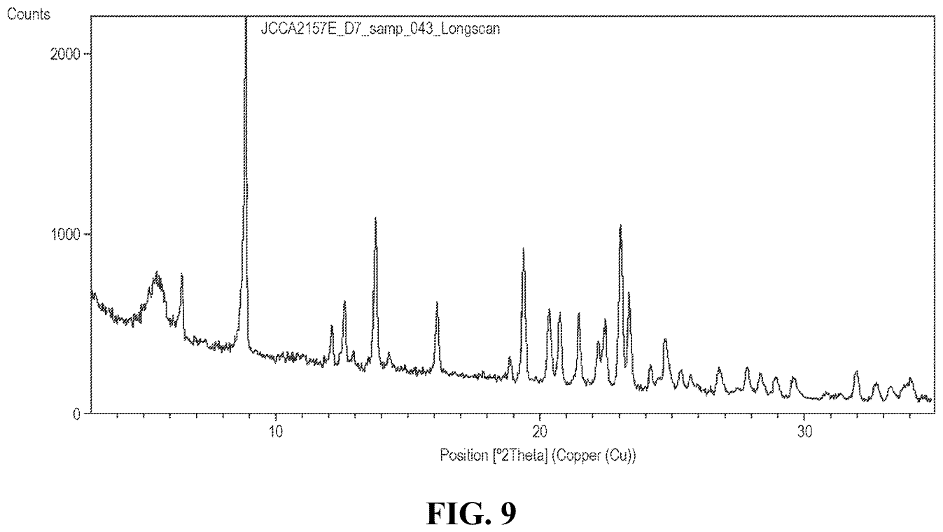

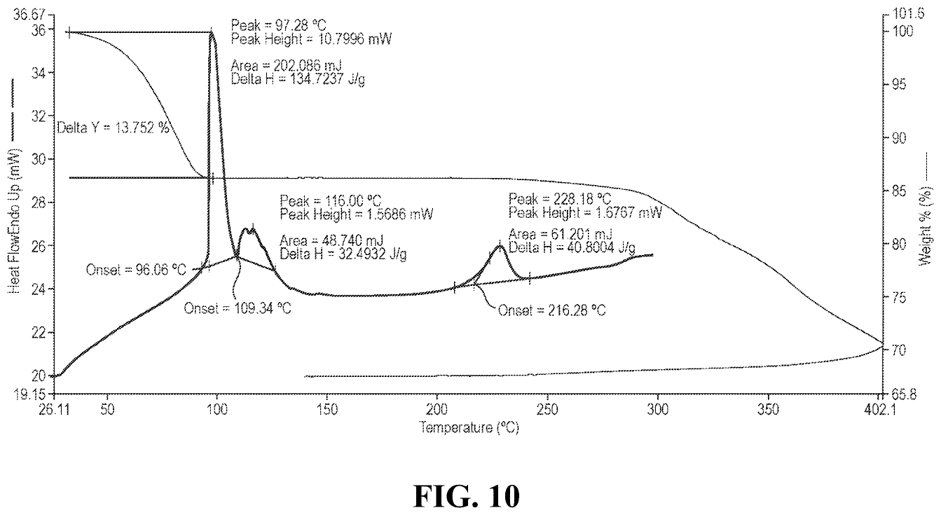

In embodiments, the present disclosure also provides a crystalline hydrate form of psilocybin, Hydrate Form A (“Hydrate A”), characterized by one or more of: (a) peaks in an XRPD diffractogram at 8.9, 12.6 and 13.8° 2θ±0.2°2θ; (b) peaks in an XRPD diffractogram at 8.9, 12.6 and 13.8°2θ±0.2°2θ, further characterized by at least one further peak at 6.5, 12.2, 19.4, 20.4 or 20.8°2θ±0.2°2θ; (c) an XRPD diffractogram as substantially illustrated in FIG. 9; or (d) an endothermic event in a DSC thermogram having an onset temperature of between 205 and 220° C. substantially as illustrated in FIG. 10. In embodiments, the variance at any of the forgoing peaks may be ±0.1. In embodiments, the crystalline hydrate form of psilocybin, Hydrate Form A (“Hydrate A”), is characterized by (a) peaks in an XRPD diffractogram at 8.9, 12.6 and 13.8°2θ±0.1°2θ; and/or (b) peaks in an XRPD diffractogram at 8.9, 12.6 and 13.8°2θ±0.1°2θ, further characterized by at least one further peak at 6.5, 12.2, 19.4, 20.4 or 20.8°2θ±0.1°2θ.

In embodiments, the crystalline hydrate form of psilocybin used in the seeding of Step (iii) of the method described herein is characterized by XRPD peaks at 8.9±0.2, 13.8±0.2, 19.4±0.2, 23.1±0.2, and 23.5±0.2°2θ. In embodiments, the variance at any of the forgoing peaks may be ±0.1. In embodiments, the crystalline hydrate form of psilocybin used in the seeding of Step (iii) of the method described herein is characterized by XRPD peaks at 8.9±0.1, 13.8±0.1, 19.4±0.1, 23.1±0.1, and 23.5±0.1°2θ.

TABLE 2
XRPD peak positions for Hydrate A (Hydrate Form A)

| Position [°2 Th.] | Relative Intensity [%] |
|---|---|
| 5.6 | 14.4 |
| 6.5 | 18.84 |
| 8.9 | 100 |
| 12.2 | 11.51 |
| 12.6 | 18.65 |
| 13.8 | 44.22 |
| 16.2 | 21.22 |
| 18.9 | 6.62 |
| 19.4 | 38.68 |
| 20.4 | 21.32 |
| 20.8 | 19.73 |
| 21.5 | 20.75 |
| 22.3 | 12.8 |
| 22.5 | 19.38 |
| 23.1 | 47.53 |
| 23.5 | 25.79 |
| 24.3 | 5.62 |
| 24.8 | 14.62 |
| 25.4 | 5.27 |
| 26.9 | 6.53 |
| 27.9 | 7.82 |
| 28.4 | 5.78 |
| 29.0 | 5.09 |
| 29.7 | 4.83 |
| 32.1 | 8.27 |
| 32.8 | 4.81 |
| 33.4 | 3.74 |
| 34.2 | 5.96 |

The peaks shown in Table 2 may have a variance of ±0.2°2θ or ±0.1°2θ.

In embodiments, psilocybin Hydrate A exhibits an XRPD diffractogram characterized by the diffractogram summarized in Table 2. In embodiments, described herein the crystalline psilocybin Hydrate A comprises at least 3 peaks of (±0.1°2θ) of Table 2. In embodiments, described herein the crystalline psilocybin Hydrate A comprises at least 4 peaks of (±0.1°2θ) of Table 2. In embodiments, described herein the crystalline psilocybin Hydrate A comprises at least 5 peaks of (±0.1°2θ) of Table 2. In embodiments, described herein the crystalline psilocybin Hydrate A comprises at least 8 peaks of (±0.1°2θ) of Table 2. In embodiments, described herein the crystalline psilocybin Hydrate A comprises at least 10 peaks of (±0.1°2θ) of Table 2.

In embodiments, crystalline psilocybin Hydrate A is characterized by XRPD diffractogram peaks at 8.9, 12.6 and 13.8° 2θ±0.2°2θ. In embodiments, crystalline psilocybin Hydrate A is further characterized by at least one peak appearing at 6.5, 12.2, 19.4, 20.4 or 20.8° 2θ±0.2°2θ. In embodiments, crystalline psilocybin Hydrate A is further characterized by at least two peaks appearing at 6.5, 12.2, 19.4, 20.4 or 20.8° 2θ±0.2°2θ. In embodiments, the variance at any of the forgoing peaks may be ±0.1. In embodiments, crystalline psilocybin Hydrate A is characterized by XRPD diffractogram peaks at 8.9, 12.6 and 13.8° 2θ±0.1°2θ. In embodiments, crystalline psilocybin Hydrate A is further characterized by at least one peak appearing at 6.5, 12.2, 19.4, 20.4 or 20.8° 2θ±0.1°2θ. In embodiments, crystalline psilocybin Hydrate A is further characterized by at least two peaks appearing at 6.5, 12.2, 19.4, 20.4 or 20.8° 2θ±0.1°2θ. In embodiments, crystalline psilocybin Hydrate A exhibits an XRPD diffractogram substantially the same as the XRPD diffractogram shown in FIG. 9.

In embodiments, crystalline psilocybin Hydrate A is characterized by an endothermic event in a DSC thermogram having an onset temperature of between 205 and 220° C., such as between 210 and 220° C., such as between 210 and 218° C., or such as between 210 and 216° C. In embodiments, crystalline psilocybin Hydrate A is further characterized by an endothermic event in the DSC thermogram having an onset temperature of between 85 and 105° C., or such as between 90 and 100° C. In embodiments, crystalline psilocybin Hydrate A is characterized by an endothermic event having an onset temperature of between 205 and 220° C., such as between 210 and 220° C., such as between 210 and 218° C., or such as between 210 and 216° C., and an endothermic event having an onset temperature of between 85 and 105° C., or such as between 90 and 100° C., in a DSC thermogram. In embodiments, crystalline psilocybin Hydrate A exhibits a DSC thermogram substantially the same as the DSC thermogram in FIG. 10.

In embodiments, crystalline psilocybin Hydrate A is characterized by having a water content of between 10 and 18%, such as between 12 and 16%, or such as about 13%. A person of ordinary skill in the art would know of methods to determine the water content of a compound, for example Karl Fischer Titration. In embodiments, crystalline psilocybin Hydrate A is characterized by having a weight loss in the TGA thermogram of between 10 and 18%, such as between 12 and 16%, or such as about 13%, between ambient temperature, such as about 25° C.

### EXAMPLES

The present disclosure is further illustrated by reference to the following Examples. However, it should be noted that these Examples, like the embodiments described above, are illustrative and are not to be construed as restricting the scope of the disclosure in any way.

The various starting materials, intermediates, and compounds of the embodiments can be isolated and purified where appropriate using conventional techniques such as precipitation, filtration, crystallization, evaporation, distillation, and chromatography. Characterization of these compounds can be performed using conventional methods such as by melting point, mass spectrum, nuclear magnetic resonance, and various other spectroscopic analyses. Exemplary embodiments of steps for performing the manufacturing of products described herein are described in greater detail infra.

### Example 1: Base Screening for Stage 4 (Synthesis of COMP360 Crude), Part A

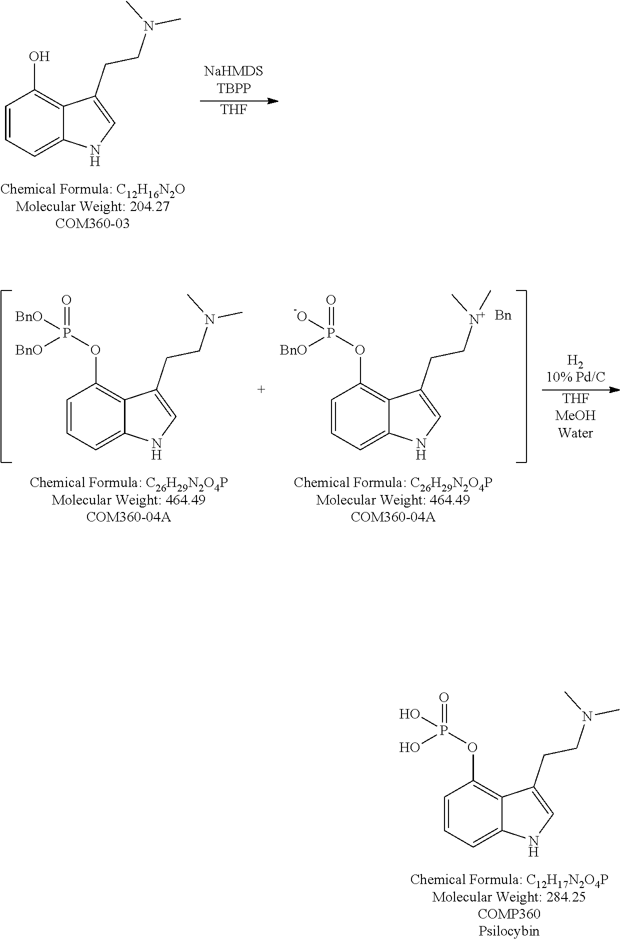

Generation of COM360-04A as a reaction intermediate during the synthesis of COMP360 (Psilocybin) was previously achieved by reacting COM360-03 with tetrabenzyl pyrophosphate (TBPP) at <−50° C. Unfortunately, these conditions limited scale up for this stage because it required cryogenic vessels. The reaction was then warmed to 0° C. before filtration to remove the DBP (dibenzylphosphate) by-product as a sodium salt. This yielded a solution of COM360-04A that was converted to insoluble COM360-04B (by warming to 40° C.), which was subsequently isolated by filtration. The reaction suffered from yield variability due to conversion of COM360-04A to COM360-04B during the initial reaction. This led to removal of the COM360-04B produced during the filtration of the DBP sodium salt. The reaction mixture was also dilute, leading to a reduced reaction throughput.

Development was therefore targeted at improving the throughput of the COM360-04A and B synthesis and defining a workable temperature range for processing that ensured high quality intermediate. Development of the COM360-04A and B reaction and workup conditions to overcome the issues with yield reproducibility observed in previous syntheses was also important.

The relative solubility of COM360-04B and COMP360 (Psilocybin) resulted in a low throughput final stage hydrogenation reaction and development of this stage to improve the productivity of the reaction was therefore targeted.

The initial trial reaction using 1. NaHMDS, THF, −50 to −60° C. then addition of TBPP followed by warming to 0° C. and filtration; 2. THF, 40° C. with COM360-03 as the starting material yielded the desired COM360-04B in 67% active yield (target ˜70%) with a purity of 77% by ¹H NMR assay (typically ˜74%). HPLC analysis indicated a purity of 86.49% (typically ˜70%). A detailed impurity profile by HPLC is provided in Table 3.

TABLE 3
Characterization of impurities (using NaHMDS as the base)

| | RRF (to | | | |
|---|---|---|---|---|
| | COM360- | | | HPLC |
| Impurity | 04B) | Mass | Structure | level |
| COM360- 04E | 0.80 | 742.73 (see 295.40 by LCMS) | 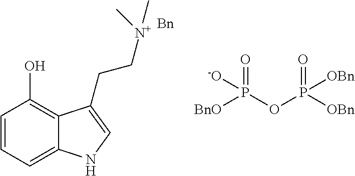 | 0.36% |
| COM360- 04F | 0.90 | 374.37 | 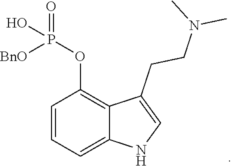 [SMILES: CN(C)CCc1c[nH]c2cccc(OP(=O)(O)OCc3ccccc3)c12] | 2.81% |
| COM360- 04B | 1.00 | 464.49 | 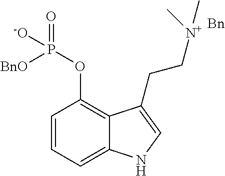 | 86.49% |
| COM360- 04C | 1.04 | 634.60 | 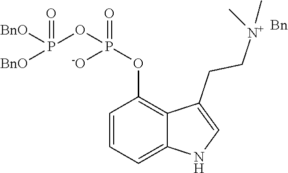 | 6.67% |
| COM360- 04G | 1.14 | 1002.96 | 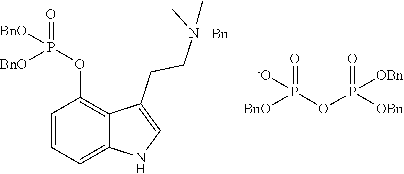 | 2.84% |

The effect of elevated reaction temperature on the reaction profile using NaHMDS was also investigated, and the key findings have been summarized below.

A reaction temperature of −10° C. to −20° C. resulted in poor reaction yield. Analysis by HPLC for the reaction performed at this temperature range determined that 40.84% COM360-03 remained unreacted prior to filtration of the DBP sodium salt by-product. The reaction was worked up to yield 4.2 g of COM360-04B (46% yield). Lastly, the reaction was repeated and a similarly low conversion of COM360-03 (23.27%) was observed. A reaction temperature of −30° C. to −40° C. led to formation of 40.84% COM360-04B and 33.80% COM360-04A with 3.43% COM360-03 remaining. These results confirmed that temperatures greater than −50° C. have an undesired impact on the reaction profile.

### Example 2: Base Screening for Stage 4 (Synthesis of COMP360 Crude), Part B

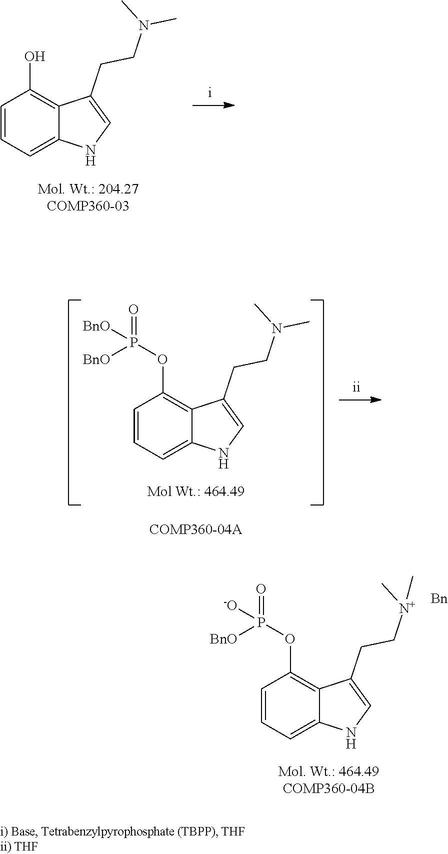

Various strong bases were screened for the reaction of Psilocin and TBPP. Initial development at this stage focused on identifying an appropriate base that provides a high yield of COMP360, is easier to handle, does not introduce more lithium, and can be performed at higher temperatures allowing for larger scale manufacturing. An initial screen of alternative conditions was carried out using the following bases: Li^{t}BuO, K^{t}BuO, NaH, NaHMDS, and K₂CO₃ (500 mg scale, 1.13 eq. base, 1.26 eq. pyrophosphate, 20 vol THF). Each reaction was initiated at a temperature of −78° C., then warmed to 0° C. overnight.

TABLE 4
Initial screen of alternative bases

| # | Base | HPLC after 1 hr | HPLC after overnight (o/n) |
|---|---|---|---|
| 1 | ⁿBuLi | 50% COM360-03, | 4% COM360-03, |
| | (2.5M in hex.) | 34% COM360-04A | 35% COM360-04A, |
| | | | 28% COM360-04B |
| 2 | NaHMDS | 7% COM360-03, | 6% COM360-03, |
| | (1M in THF) | 70% COM360-04A, | 57% COM360-04A, |
| | | 3% COM360-04B | 24% COM360-04B |
| 3 | NaH | 79% COM360-03, | 3% COM360-03, |
| | (60% in oil) | 6% COM360-04A | 47% COM360-04A, |
| | | | 28% COM360-04B |
| 4 | NaO^{t}Bu | 11% COM360-03, | 6% COM360-03, |
| | | 60% COM360-04A, | 34% COM360-04A, |
| | | 8% COM360-04B | 28% COM360-04B |
| 5 | KO^{t}Bu | 54% COM360-03, | 15% COM360-03, |
| | (2M in THF) | 13% COM360-04A, | 10% COM360-04A, |
| | | 2% COM360-04B | 31% COM360-04B |
| 6 | LiO^{t}Bu | 61% COM360-03, | 16% COM360-03, |
| | (2M in THF) | 7% COM360-04A, | 8% COM360-04A, |
| | | 1% COM360-04B | 11% COM360-04B |
| 7 | K₂CO₃ | 15% COM360-03, | 0% COM360-03, |
| | | 3% COM360-04A, | 0% COM360-04A, |
| | | 67% COM360-04B | 76% impurity |

All the reactions became very thick with gelling observed especially in #1, #2, and #3 (#7 was thick but broke down upon rapid stirring). The reaction using K₂CO₃ (#7) afforded complete consumption of the starting material, however the isolated product from this reaction was not COM360-04B (further discussion in Example 3). LCMS analysis was carried out which gave m/z of 295.2. This isolated product was a minor component in the other COM360-04B reactions eluting slightly before the desired product. By ¹H NMR a slight difference in chemical shift was noted when compared to a genuine COM360-04B sample.

The reaction was also trialed using NaNH₂ as the base. The reaction was initiated at −50° C. and allowed to warm to −30° C. over 30 min, to −15° C. over 1 hr, and then to 5° C. over 2 hrs. Due to the slow reaction rate (see Table 5), testing of this base was not pursued further.

TABLE 5
Reaction progression with NaNH₂

| Timepoint | HPLC completion - NaNH₂ |
|---|---|
| 0.5 hrs, −30° C. | 63% COM360-03, 3% COM360-04A |
| 1 hr, −15° C. | 56% COM360-03, 21% COM360-04A |
| 2 hrs, 5° C. | 52% COM360-03, 24% COM360-04A |

The initial screening suggested that NaHMDS (81% conversion to product/intermediate 4A) appeared to be a more suitable alternative to ⁿBuLi than Li^{t}BuO, K^{t}BuO, NaH, and K₂CO₃. These conditions were scaled up to 1.5 g alongside a reference reaction with ⁿBuLi (Table 6). Overhead stirring was used in both cases due to the thickening of the reaction mixture as previously noted.

TABLE 6
Comparison of ⁿBuLi and NaHMDS

| Timepoint | HPLC - ⁿBuLi | HPLC - NaHMDS |
|---|---|---|
| 1 hr, −30° C. | 6.6% COM360-03, | <1% COM360-03, |
| | 78% COM360-04A, | 78% COM360-04A, |
| | 1% COM360-04B | 4% COM360-04B |
| 2 hr, 0° C. | 6.5% COM360-03, | <1% COM360-03, |
| | 77% COM360-04A, | 76% COM360-04A, |
| | 1% COM360-04B | 4% COM360-04B |
| Crude product | 4.89 g | 4.38 g |
| | <1% COM360-03, | <1% COM360-03, |
| | 2% COM360-04A, | 5% COM360-04A, |
| | 60% COM360-04B | 68% COM360-04B |

As shown in Table 6, the reaction profiles obtained in experiments using ⁿBuLi and NaHMDS were similar. Notably, the reaction using NaHMDS consumed nearly all of the starting material (COM360-03). Both reactions were filtered on Celite to remove a white precipitate and subsequently concentrated. ¹H NMR analysis showed excess benzyl protons were present in both cases (especially in the example with ⁿBuLi) with an isolated yield of >100%.

### Example 3: Base Screening for Stage 4 (Synthesis of COMP360 Crude), Part C

Example 1 provides assessment of several bases for the COMP360 conversion, namely ⁿBuLi, NaHMDS, NaH, NaO^{t}Bu, KO^{t}Bu, LiO^{t}Bu, K₂CO₃, and NaNH₂. Further investigation was needed to identify a suitable base for larger scale manufacturing. During the initial screening, the use of K₂CO₃ appeared promising (see Table 4). However, extended stir (>1 h) led to the formation of COM360-04E (see Table 4). The initial results with K₂CO₃ suggested further investigations into alternative bases would be worthwhile. Trial reactions were therefore carried out with various inorganic bases and pyridine (Table 7). The reactions were carried out at 0-5° C. then warmed slowly to room temperature overnight. During the experiments, early formation of COM360-04E was consistently observed in each case within 1 hour. After 18 hours, COM360-04E became the predominant species in each case.

TABLE 7
Additional base screening

| Base | 1 h (0-5° C.) | 18 h (0-5° C. to rt) |
|---|---|---|
| K₂CO₃ | COM360-03 68.18% | COM360-03 8.22% |
| | COM360-04A 2.60% | COM360-04A 1.04% |
| | COM360-04B 0.70% | COM360-04B 2.18% |
| | COM360-04E 15.27% | COM360-04E 74.63% |
| CS₂CO₃ | COM360-03 69.13% | COM360-03 8.89% |
| | St4 Int 2.44% | COM360-04A 1.54% |
| | COM360-04B 1.47% | COM360-04B 20.48% |
| | COM360-04E 15.27% | COM360-04E 24.93% |
| NaHCO₃ | COM360-03 69.92% | COM360-03 12.61% |
| | COM360-04A 2.65% | COM360-04A 1.79% |
| | COM360-04B 0.97% | COM360-04B 1.31% |
| | COM360-04E 15.65% | COM360-04E 72.68% |
| Na₂CO₃ | COM360-03 65.44% | COM360-03 8.64% |
| | COM360-04A 2.99% | COM360-04A 0.74% |
| | COM360-04B 1.99% | COM360-04B 3.12% |
| | COM360-04E 18.00% | COM360-04E 70.36% |
| Pyridine | COM360-03 69.08% | COM360-03 13.24% |
| | COM360-04A 2.74% | COM360-04A 1.58% |
| | COM360-04B 1.21% | COM360-04B 1.35% |
| | COM360-04E 16.02% | COM360-04E 71.21% |

The reaction using pyridine was filtered and the solids washed with THF. LCMS analysis of the solids confirmed the mass for the impurity. ¹H NMR indicated the presence of four benzyl groups confirming the impurity was isolated with a TBPP counter-ion as indicated in Table 5 (COM360-04E). While the above bases allowed for conditions favorable to large scale manufacturing, the yield of the desired product was low. This is believed to be due to the inability of these bases to deprotonate the phenol of the starting material Psilocin (COM360-03). From the above experiments, it was concluded that formal deprotonation of the phenol is required for the desired reaction to progress.

### Example 4: Base Screening for Stage 4 (Synthesis of COMP360 Crude), Part D

To achieve formal deprotonation of the phenol, the use of Grignard reagent iPrMgCl as an alternative to NaHMDS was investigated. The use of 1.13 eq iPrMgCl (0-5° C., 1.26 eq TBPP) resulted in formation of 53.06% COM360-04B and 14.67% COM360-04A (1.03% COM360-03, 23.08% COM360-04G) after 2 hours. After overnight stir, the reaction formed 47.83% COM360-04B and 25.55% COM360-04A (18.44% COM360-04G).

Using iPrMgCl as the base may allow reactions to be conducted at higher temperature and under greater concentrated conditions. However, further trials indicated that an excess of the base was required to reduce the formation of COM360-04E:

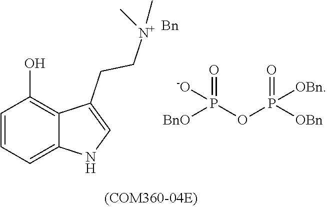

Although the overall product conversion rate using iPrMgCl was comparable to that of NaHMDS, the use of iPrMgCl resulted in elevated levels of impurity COM360-04E (5-10%), whereas NaHMDS resulted in <1% of this impurity. Despite attempts to isolate COM360-04B impurity from the reactions using iPrMgCl, the level of this impurity remained effectively unchanged after attempted isolation. Because this impurity would convert to COM360-03 (starting material) in the subsequent hydrogenation reaction, the use of NaHMDS appeared to be more beneficial than iPrMgCl. It is noted that low reaction temperatures are required using NaHMDS as the base (<−50° C., see Example 2).

### Example 5: Stage 3—Synthesis of Crude 3-[2-(dimethylamino)ethyl]-1H-indol-4-yl dihydrogen phosphate (Crude COMP360)

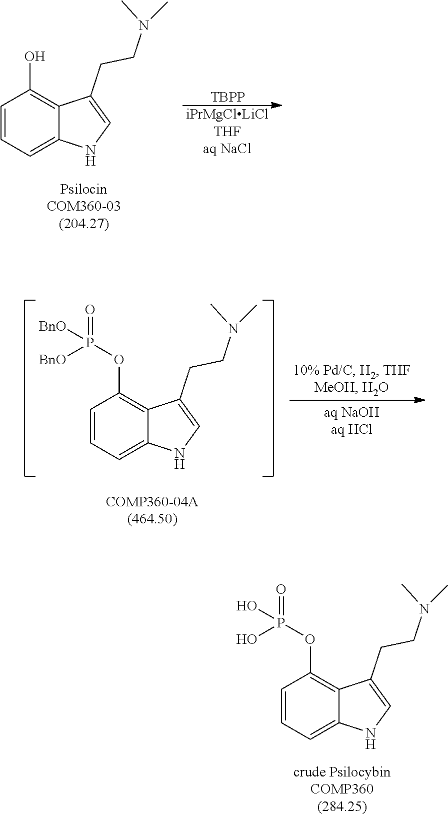

High reactivity of strong bases such as organolithium and Grignard reagents generally necessitates reactions be carried out at low reaction temperatures (e.g., −78° C.) in order to achieve adequate selectivity. Therefore, it is often a challenge to achieve efficient reaction processes (high yield) under more practical (non-cryogenic) conditions. Surprisingly, it was discovered that using a particular type of Grignard reagent as the base, namely isopropylmagnesium chloride lithium chloride complex ((CH₃)₂CHMgCl·LiCl, “Turbo Grignard reagent”) provided good selectivity and allowed the reaction to be conducted at temperatures between 1-11° C. or 0-5° C. (increased from <−50° C. in NaHMDS) without any decrease in reaction efficiency. Without being bound by theory, it is believed that using the Turbo Grignard reagent as base obviates a need to isolate intermediates such as COM360-04B, as was observed during reactions with other bases (e.g., NaHMDS, see Examples 2-4). As such, no additional isolation of impurities such as COM360-04B is needed, which leads to a clean and efficient product formation. Additionally, performing the reaction at a higher temperature circumvents the need for a cryogenically cooled reaction vessel (largest scale at the manufacturer is 20 L) and allows for use of a larger reaction vessel (50 L) with a standard heating/cooling capacity. This allows production capacity to more than double while also reducing production cost.

Detailed steps of Stage 3 synthesis of COMP360 crude from COM360-03 using the Turbo Grignard reagent are provided as follows.

Step (i): COM360-03 was charged to a vessel followed by THF. The reaction mixture was stirred and cooled to 0-5° C. and a 1.3M solution of isopropylmagnesium chloride lithium chloride complex (iPrMgCl·LiCl) in THF was added dropwise while maintaining the temperature between 0-5° C. and stirred for <2 hours. Tetrabenzylpyrophosphate (TBPP) (1.26 molar equivs) was added, and the batch was stirred at 0-5° C. for 30-60 minutes. An aqueous sodium chloride solution was added, keeping the temperature below 25° C. followed by water and the mixture was stirred at 0-25° C. for 10-30 minutes. The organic layer was washed with aqueous sodium chloride solution and the aqueous layer was removed.

Step (ii): 10% palladium on activated charcoal support (Pd/C) (˜50% wet), methanol and water were added and the resulting mixture was sparged with hydrogen, heated to 40-50° C. and stirred for at least 12 hours until the reaction was determined to be complete using HPLC (IPC-4). The mixture was purged with nitrogen for at least 10 minutes and the pH adjusted to 6-7 using a solution of sodium hydroxide in water at 40-50° C. The mixture was filtered (hot) then the filter cake was washed twice with hot water (pre-heated to 80-90° C.) to ensure complete dissolution. The pH was adjusted to 6-7 using aqueous sodium hydroxide solution (if needed) and the solvent was concentrated under vacuum at a maximum temperature of 40° C., and pressure 30-40 mbar. The pH was adjusted to 4.0-4.3 using concentrated aqueous HCl then heated to 70-80° C. to achieve dissolution and was stirred for 20-40 minutes, then filtered hot. The temperature was adjusted to 70-75° C., methanol was slowly added while maintaining temperature, and then cooling to 15-25° C. was initiated at approximately 10° C./hr. During cooling, the mixture was seeded with a crystalline hydrate form of psilocybin, COMP360 Hydrate Form A, at 68-70° C. Then, cooling was continued, and suspension was stirred at 15-25° C. for at least 12 hours. The suspension was cooled to 0-5° C. and stirred for at least 1 hour (maximum 4 hours). The suspension was filtered, the cake washed with water then dried in-vacuo at 50° C. to yield crude COMP360 [IPC-5].

The product was optionally re-slurried in methanol at 45-55° C., cooled, filtered, and dried to provide further purification if required. The yields of crude COMP360 were 56%, 60%, 46% and 54% (4 batches).

A modified procedure of Stage 3 synthesis of COMP360 crude from COM360-03 using the Turbo Grignard reagent is provided below.

Step (i): COMP360-03 was charged to a vessel followed by THF. The reaction mixture was stirred and cooled to 1-11° C. (hold point) and a 1.3M solution of isopropylmagnesium chloride lithium chloride complex (iPrMgCl·LiCl) in THF was added dropwise while maintaining the temperature between 1-11° C., and then stirred for 10-20 minutes or about 15 minutes. Tetrabenzylpyrophosphate (TBPP) was added at 1-11° C., and the batch was stirred at 1-11° C. for 10-20 minutes. An aqueous sodium chloride solution was added, keeping the temperature below 25° C. followed by water and the mixture was stirred at 0-25° C. for 60-80 minutes. The stirring was stopped for at least 2 hours and the phases were separated. The organic layer was washed with aqueous sodium chloride solution, stirred at 0-25° C. for 10-30 minutes and the aqueous layer removed. The stirring was stopped for at least 45 minutes before separating the layers.

The pH was adjusted to 3-4 using 85% w/w H₃PO₄. The reaction was split into two equal portions; the first half was filtered through a wet celite plug, followed by the filtration of the second portion through a second wet celite plug. Both filter cakes were washed twice with methanol (hold point). The filtrates from the second Methanol washes were collected in a clean flask and evaporated under vacuum. On completion, this was combined with the remaining filtrates and transferred into a clean vessel for hydrogenation. The mixture was stirred, and the temperature was adjusted to 15-25° C. The pH was adjusted to 2.44-3.44 using 85 w/w % H₃PO₄.

Step (ii): 10% palladium on activated charcoal support (Pd/C) (˜50% wet) and water were added between 15-25° C. and the resulting mixture was sparged with hydrogen, and stirred for at least 16 hours until the reaction was determined to be complete using HPLC (IPC-6). The mixture was purged with nitrogen for at least 10 minutes and the pH of the reaction mixture was adjusted to 6-7 using a solution of sodium hydroxide in water at 40-50° C. The mixture was filtered (hot) then the filter cake was washed with hot water (80-90° C.) to ensure complete dissolution of COMP360 in filter cake. The layers of the filtrate were separated, and the top toluene layer was discarded. The pH was adjusted to 6-7 using aqueous sodium hydroxide solution (hold point). The solvent was concentrated under vacuum at a maximum temperature of 40-60° C. to leave 6.94 to 7.22 volume. The solution was transferred to a clean vessel at 15-25° C., and the pH was adjusted to 3.21-4.21 using HCl then the solution was stirred for at least 15 minutes while maintaining temperature. The solution was heated to 70-80° C. to achieve dissolution and was stirred for 20-40 minutes, then filtered hot through GF/F filter media. The filtrate was charged back to the vessel and the temperature was adjusted to 70-75° C. then methanol was slowly added while maintaining temperature. Cooling to 15-25° C. was initiated at 10.4-14.4° C./hr. During cooling, the mixture was seeded at 68-70° C., then cooling was continued, and suspension was equilibrated at 15-25° C. for at least 12 hours (hold point). The suspension was cooled to −6 to 4° C. over 30 minutes and equilibrated for 1-4 hours. The suspension was filtered, the cake washed with water then dried in-vacuo at 50° C. to yield crude COMP360 [IPC-7].

The product was reslurried in methanol and water at 55-65° C. for at least 5 hours (hold point), cooled to 0-10° C. at 10° C./hr, stirred at 5° C. for at least 12 hours (hold point), filtered then dried in-vacuo at 50° C. to provide further purification if required [IPC-8].

### Example 6: Stage 4—Synthesis of 3-[2-(dimethylamino)ethyl]-1H-indol-4-yl dihydrogen phosphate (COMP360) (Crystalline Form of Psilocybin)

Detailed steps of Stage 4 synthesis of COMP360 (crystalline form of Psilocybin; Anhydrate Form A) from the COMP360 crude are provided as follows.

Crude COMP360 was dissolved in purified water at 70-80° C. The resulting bulk solution was then polish filtered (hot) into a pre-warmed vessel. The temperature was adjusted to 70-75° C. Cooling to 15-25° C. at approximately 10° C./hr was initiated and the pre-prepared COMP360 Hydrate Form A seed was added to the solution at 68-70° C. Cooling was continued and the suspension was equilibrated at 15-25° C. and stirred for at least 12 hours. The suspension was cooled to 0-5° C. and equilibrated for at least 1 hour. The product was filtered and washed with purified water. The isolated solids were then dried in vacuo at 50° C. to yield COMP360 (Anhydrate Form A). The yields of COMP360 were 91%, 82%, 77%, and 86% (4 batches).

A modified procedure of Stage 4 synthesis of COMP360 (crystalline form of Psilocybin; Anhydrate Form A) from the COMP360 crude is provided below.

Crude COMP360 was dissolved in purified water at 70-80° C. The resulting bulk solution was then polish filtered (hot) into a pre-warmed vessel. The temperature was adjusted to 70-75° C. Cooling to 61-67° C. at approximately 5° C./hr was initiated and the preprepared COMP360 hydrate seed was added to the solution at 61-67° C. and stirred at 2 hours to allow crystallization to develop. Cooling was continued to 15-25° C. at approximately 4.1-10.1° C./h and the suspension was equilibrated at 15-25° C. and stirred for at least 12 hours (max hold 24 hours). The suspension was cooled to 0-10° C. at approximately 5° C./h and equilibrated for at least 1 hour (hold max 72 hours [sum of equilibration at 15-25° C. and to 0-10° C.]). The product was filtered and washed with purified water. The isolated solids were then dried in vacuo at 60° C. for e.g., 1 day to yield COMP360.

### Example 7: Stage 0—Synthesis of 4-acetoxyindole

Detailed steps of Stage 0 synthesis of 4-acetoxyindole from 4-hydroxyindole are provided as follows.

4-Hydroxyindole was charged to a vessel followed by EtOAc. The reaction mixture was stirred and adjusted to a temperature of 20-30° C. Triethylamine followed by acetic anhydride were added dropwise. The mixture was stirred at 20-30° C. for at least 2 h (In-process control [IPC]-1). The reaction was cooled to 15-25° C. and was then quenched by addition of water dropwise while maintaining the temperature between 15-25° C. The mixture was stirred for at least 10 minutes, then phase separation was performed to leave the top EtOAc layer in the vessel. An aqueous citric acid solution was added while keeping the temperature at 15-25° C. Another phase separation was performed to leave the top EtOAc layer in the vessel. An aqueous K₂CO₃ solution was added while keeping the temperature at 15-25° C. The organic layer was collected, dried with MgSO₄, then filtered with a filter cake, which was washed with EtOAc. The filtrate was concentrated, charged with n-heptane, and dried in vacuo to yield 4-acetoxyindole is a light beige to brown or light to dark brown colored solid. The yields of 4-acetoxyindole were 87% and 88% (2 batches).

### Example 8: Stage 1—Synthesis of 3-[(dimethylamino)(oxo)acetyl]-1H-indol-4-yl acetate (COM360-02)

Detailed steps of Stage 1 synthesis of COM360-02 from 4-acetoxyindole are provided as follows.

Oxalyl chloride was added slowly to a stirred mixture of tetrahydrofuran (THF) and t-butyl methyl ether (TBME) maintaining the temperature at 15-25° C. The reaction was warmed and a solution of 4-acetoxyindole dissolved in a mixture of THF and TBME was added. The reaction was stirred for at least 1.5 h. The reaction was cooled to −10 to 9° C. and a solution of 2 M dimethylamine in THF was added dropwise while maintaining the temperature between −10 to 9° C. The reaction was then stirred for at least 1.5 h at −10 to 9° C. The product was filtered, washed successively with a mixture of THF/TBME followed by n-heptane and dried (IPC-1). The crude product was further purified by a slurry in water at 15-25° C. and then dried in a vacuum oven at 60° C. The yields of COM360-02 were 80%, 80%, 81%, 82%, 74%, and 76% (6 batches).

A modified procedure of Stage 1 synthesis of COM360-02 from 4-acetoxyindole is provided below.

Oxalyl chloride was added slowly to a stirred mixture of tetrahydrofuran (THF) and t-butyl methyl ether (TBME) maintaining the temperature at 15-25° C. The reaction was warmed to 25-47° C., 31-41° C., or about 36° C. and a solution of 4-acetoxyindole dissolved in a mixture of THF and TBME was added over a period of 20-54 minutes, such as about 37 minutes or about 50 minutes, while maintaining temperature at 31-41° C. The reaction was stirred for 1.5-2.5 h. The reaction was cooled to −1 to 9° C. and a solution of 2M dimethylamine in THF was added dropwise over a period of 20-121 minutes or 55-150 minutes, such as about 71 minutes or about 100 minutes, while maintaining the temperature between −1 to 9° C. The reaction was then stirred for 1.5-2.5 h at −1 to 9° C. The product was filtered at −1 to 9° C. The filtrate was recharged to the vessel and stirred for at least 15 minutes at −1 to 9° C. The filter cake was washed successively with a mixture of THF/TBME followed by n-heptane and dried. The crude product was further purified by a slurry in water at 15-25° C. for at least 1.5 hours. The slurry could be carried out overnight (hold point). The suspension was filtered then the filtrate was recharged to the vessel used to rinse the solids. The filter cake was then washed with water and dried and then washed with 2-propanol and dried (In-process control [IPC]-1). The solids were dried in a vacuum oven at 60° C. (IPC 2).

### Example 9: Stage 2—Synthesis of 3-(2-(dimethylamino)ethyl)-1H-indol-4-ol (psilocin) (COM360-03)

Detailed steps of Stage 2 synthesis of COM360-03 from COM360-02 are provided as follows.

COM360-02 was slurried in THF and cooled to 0-10° C. A THF solution of 2.4 M lithium aluminium hydride (LiAlH₄) was added dropwise while maintaining the temperature between 0-20° C. The reaction was stirred for a further 30-60 minutes at 15-25° C. then warmed to 60-65° C. and stirred for at least 12 hours (IPC-2). The reaction was cooled to 0-10° C. and the excess LiAlH₄ quenched by addition of acetone followed by aqueous citric acid solution while maintaining temperature between 0-30° C. The mixture was stirred for at least 1 h at 15-25° C., then filtered and the filter cake was washed with THF. The filter cake was slurried with a mixture of THF and aqueous citric acid solution for at least 2 hours. The batch was filtered, and the filter cake was washed with THF. The combined filtrates were concentrated at a maximum temperature of 50° C. then filtered through a silica pad. The pad was eluted with THF and the product containing fractions evaporated at a maximum temperature of 50° C. (IPC-3). The resulting solid was slurried in isopropyl acetate (iPrOAc):TBME mixture, stirred at 15-25° C. for at least 2 hours, filtered and washed with TBME. The solid was dried under vacuum at 40° C. The yields of COM360-03 were 58%, 62%, 63%, 61%, 59%, 61%, and 59% (7 batches).

A modified procedure of Stage 2 synthesis of COM360-03 from COM360-02 is provided below.

COM360-02 was slurried in THF and cooled to 9-19° C. A THF solution of 1M lithium aluminium hydride (LiAlH₄) was added dropwise while maintaining the temperature between 9-19° C. The reaction was stirred for a further 30-60 minutes at 15-25° C. then warmed to 53-66° C., 53-63° C., or about 65° C. and stirred for at least 12 hours (hold point: reaction was stable for at least 3 days) (IPC-3). The reaction was cooled to 0-10° C. and the excess LiAlH₄ quenched by addition of acetone followed by aqueous citric acid solution while maintaining temperature between 0-30° C. The mixture was stirred for at least 1 h at 15-25° C. (optional hold point), then filtered under nitrogen and the filter cake was washed with THF. The filter cake was slurried with a mixture of THF and water at 15-25° C. for at least 2 hours (hold point). The batch was filtered under nitrogen and the filter cake was washed with THF and dried. The combined filtrates were concentrated at a maximum temperature of 50° C. (IPC 4). The resulting solid was slurried in isopropyl acetate (iPrOAc):TBME mixture, stirred at 15-25° C. for at least 2 hours (hold point), filtered under nitrogen and washed with TBME. The product was further purified by a slurry in water at 15-25° C. for at least 2 hours, filtered, then the filter cake was washed with water. Solids were gently broken then dried under vacuum at 40° C. (IPC-5). If KF (Karl Fischer) specification was not met, drying was continued. If ROI specification was not met, water purification and drying steps would be repeated followed by retest.

### Example 10: COMP360 Batch Analysis Data

Table 8 provides a summary of the acceptance criteria and analysis data of batches of COMP360 obtained via the procedure disclosed herein.

TABLE 8
COMP360 batch analysis data

| | Test^{▾} | | | | | | |
|---|---|---|---|---|---|---|---|
| | Acceptance criteria* | | | Batch 240836 | Batch 240960 | Batch 240961 | Batch 240962 |
| | Manufacturing Date | | | | | | |
| | — | | | 29 Aug. 2024 | 27 Sep. 2024 | 1 Oct. 2024 | 4 Oct. 2024 |
| | Batch size | | | | | | |
| | | | | 890.2 g | 617.5 g | 354.4 g | 760.2 g |
| Appearance | A white to light brown solid | | | Off-white solid. | Off-white solid. | Off-white solid. | Off-white |
| | | | | Free from | Free from | Free from | solid. Free |
| | | | | visible | visible | visible | from visible |
| | | | | contamination. | contamination. | contamination. | contamination. |
| Identity by FT-IR | Conforms to reference spectrum | | | Conforms | Conforms | Conforms | Conforms |
| Identity by | Retention time ± 5% that of the reference standard | | | Conforms | Conforms | Conforms | Conforms |
| HPLC | | | | | | | |
| Chromatographic | COMP360 | NLT 98.0% | | 99.62% | 99.76% | 99.74% | 99.72% |
| purity by HPLC | Psilocin (COMP360-03) | NMT 1.0% area | | 0.26% | 0.13% | 0.18% | 0.16% |
| | COMP360-04P | NMT 0.15% or 0.25% area | | 0.05% | 0.05% | <0.05% | 0.05% |
| | (Peak C)^{▪} | | | | | | |
| | Individual unspecified | NMT | COMP360-04L | <0.05% | <0.05% | ND | <0.05% |
| | impurity: | 0.10% | (Peak A): | | | | |
| | | area | Peak B | 0.05% | 0.05% | <0.05% | <0.05% |
| | | | (COMP360-04M + | | | | |
| | | | COMP360-04N)▪ | | | | |
| | Total impurities | NMT 2.0% | | 0.39% | 0.24% | 0.26% | 0.28% |
| DBP and TBPP | DBP | NMT 0.15% area | | ND | ND | ND | ND |
| content by HPLC | TBPP | NMT 0.15% area | | ND | ND | ND | ND |
| Assay by HPLC | 97.0-102.0% w/w | | | 98.52% | 99.98% | 100.85% | 100.59% |
| (anhydrous and | | | | | | | |
| solvent free) | | | | | | | |

| Residual Water | NMT 2.0% w/w | | 0.95% | | 0.88% | | 0.84% | 0.84% |
|---|---|---|---|---|---|---|---|---|
| content by KF | Methanol | NMT 3000 ppm | | | | | | |
| Residual Solvent | THF | NMT 720 ppm | 16 | ppm | <4 | ppm | <4 ppm | <4 ppm |
| content | Toluene | NMT 890 ppm | <2 | ppm | ND | | ND | ND |
| | Ethanol | NMT 5000 ppm | ND | | ND | | ND | ND |
| | Acetone | NMT 5000 ppm | <6 | ppm | ND | | ND | ND |
| | 2-Propanol | NMT 5000 ppm | 20 | ppm | 1 | ppm | ND | ND |

| | | | | | | |
|---|---|---|---|---|---|---|
| Isopropyl acetate | NMT 5000 ppm | <8 | ppm | ND | ND | ND |

| | TBME | NMT 5000 ppm | ND | ND | ND | ND |
|---|---|---|---|---|---|---|
| | n-Heptane | NMT 5000 ppm | ND | ND | ND | ND |
| | | NMT 5000 ppm | ND | ND | ND | ND |
| Phosphoric acid | NMT 1.0% w/w | | ND | ND | ND | ND |
| content | | | | | | |
| Residue on | NMT 0.5% w/w | | 0.14% | 0.15% | 0.1% | <0.1% |
| Ignition | | | | | | |
| Elemental | Cd | ≤0.5 ppm | NMT 0.1 ppm | NMT 0.25 ppm | NMT 0.25 ppm | NMT 0.25 ppm |
| impurities | Pb | ≤0.5 ppm | NMT 0.1 ppm | NMT 0.25 ppm | NMT 0.25 ppm | NMT 0.25 ppm |
| | As | ≤1.5 ppm | NMT 0.1 ppm | NMT 0.75 ppm | NMT 0.75 ppm | NMT 0.75 ppm |
| | Hg | ≤3 ppm | NMT 0.01 ppm | NMT 1.5 ppm | NMT 1.5 ppm | NMT 1.5 ppm |
| | Co | ≤5 ppm | NMT 0.1 ppm | NMT 2.5 ppm | NMT 2.5 ppm | NMT 2.5 ppm |
| | V | ≤10 ppm | NMT 0.1 ppm | NMT 5 ppm | NMT 5 ppm | NMT 5 ppm |
| | Ni | ≤20 ppm | 0.42 ppm | NMT 10 ppm | NMT 10 ppm | NMT 10 ppm |
| | Pd | ≤10 ppm | NMT 0.1 ppm | NMT 5 ppm | NMT 5 ppm | NMT 5 ppm |
| | Li | ≤165 ppm | NMT 0.1 ppm | NMT 82.5 ppm | NMT 82.5 ppm | NMT 82.5 ppm |

| | | | | | |
|---|---|---|---|---|---|
| Polymorphic | Conforms to reference diffractogram | Conforms | Conforms | Conforms | Conforms |
| Form | | | | | |

DBP = Dibenzylphosphate;
HPLC = high-performance liquid chromatography;
ND = Not detected;
NMT = Not more than;
PPM = parts per million;
TBME: Tert butyl methyl ether;
TBPP = tetrabenzylpyrophosphate;
THF = Tetrahydrofuran;
w/w = weight/weight
^{▾}FP/COMP360-PHASE3/Issue11
*specification in place at time of testing
^{▪}Previously referred to as “Peak C”
▪Peak B (COMP360-04M + COMP360-04N) is a combination of two co-eluting peaks (COMP360-04M and COMP360-04N) in the method ONYX-MVR-417, If the sum of these two peaks is greater than 0.10% additional testing will be applied.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method of manufacturing psilocybin from psilocin, comprising:
(i) mixing psilocin and tetrabenzylpyrophosphate (TBPP) in the presence of a Grignard reagent to form a reaction mixture; and
(ii) subjecting the reaction mixture to hydrogen in the presence of a catalyst to form psilocybin,
wherein the Grignard reagent is a lithium chloride complex Grignard reagent of Formula (I) 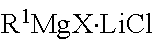
wherein:
R¹ is optionally substituted C₁-C₁₂ alkyl, optionally substituted C₂-C₁₂ alkenyl, optionally substituted C₂-C₁₂ alkynyl, optionally substituted C₃-C₉ cycloalkyl, or optionally substituted C₆-C₁₈ aryl; and
X is Cl, Br, or I.

2. The method of claim 1, further comprising:
(iii) crystallizing the psilocybin from water, thereby forming a crystalline form of psilocybin.

3. The method of claim 1, wherein R¹ is optionally substituted C₁-C₄ alkyl.

4. The method of claim 1, wherein R¹ is methyl, ethyl, n-propyl, isopropyl, n-butyl, isobutyl, sec-butyl, or tert-butyl.

5. The method of claim 1, wherein R¹ is isopropyl.

6. The method of claim 1, wherein X is Cl.

7. The method of claim 1, wherein the Grignard reagent is isopropylmagnesium chloride lithium chloride complex ((CH₃)₂CHMgCl·LiCl).

8. The method of claim 1, wherein the mixing in step (i) is performed in an organic solvent.

9. The method of claim 8, wherein the organic solvent is tetrahydrofuran (THF).

10-14. (canceled)

15. The method of claim 1, wherein the mixing in step (i) comprises:
(i-1) mixing psilocin and the Grignard reagent to form a first mixture; and
(i-2) mixing TBPP with the first mixture to form the reaction mixture.

16. The method of claim 15, wherein the first mixture is formed by mixing psilocin and the Grignard reagent at a temperature greater than −50° C. for up to 2 hours.

17. The method of claim 15, wherein the first mixture is formed by mixing psilocin and the Grignard reagent at a temperature from about −10° C. to about 25° C. for up to 2 hours.

18. The method of claim 15, wherein the first mixture is formed by mixing psilocin and the Grignard reagent at a temperature from about 0° C. to about 13° C. for 0.5 hours to 1 hour.

19. The method of claim 1, wherein a molar ratio of the Grignard reagent to psilocin ranges from about 1:1 to about 2:1.

20. (canceled)

21. The method of claim 1, wherein a molar ratio of the TBPP to psilocin ranges from about 1:1 to about 3:1.

22. (canceled)

23. The method of claim 1, wherein step (i) further comprises quenching the reaction mixture with water or an aqueous solution prior to step (ii).

24. The method of claim 23, wherein the quenching prior to step (ii) comprises:
(i-3) mixing the reaction mixture of step (i) with a water or an aqueous solution at a temperature below 25° C. for less than 30 minutes to form an aqueous layer and an organic layer; and
(i-4) collecting the reaction mixture which is present in the organic layer.

25. The method of claim 1, wherein benzyl 3-[2-(benzyldimethylazaniumyl)ethyl]-1H-indol-4-yl phosphate is not isolated.

26. The method of claim 1, wherein the catalyst in step (ii) is a palladium on carbon (Pd/C) catalyst.

27. The method of claim 2, wherein the crystallizing in step (iii) comprises:
combining the psilocybin and about 10-20 volumes of water to form an aqueous mixture;
heating the aqueous mixture with agitation to a temperature of at least 70° C. to provide a solution;
filtering the solution to form a filtered solution;
seeding the filtered solution at a temperature of about 70° C. to form a seeded suspension;
cooling the seeded suspension to a temperature of about 5° C. over a period of more than 2 hours to form a cooled suspension;
filtering the cooled suspension to form a solid; and
drying the solid thereby forming the crystalline form of psilocybin.

28. The method of claim 27, wherein the seeding comprises adding crystalline hydrate of psilocybin to the filtered solution, wherein the crystalline hydrate of psilocybin is characterized by X-ray powder diffraction (XRPD) peaks at 8.9±0.1, 13.8±0.1, 19.4±0.1, 23.1±0.1, and 23.5±0.1°2θ.

29. The method of claim 1, wherein the psilocin is manufactured by a method comprising:
(1) reacting 1H-indol-4-yl acetate with oxalyl chloride and dimethylamine to form 3-([(dimethylcarbamoyl)carbonyl])-1H-indol-4-yl acetate; and
(2) reacting 3-([(dimethylcarbamoyl)carbonyl)-1H-indol-4-yl acetate with lithium aluminum hydride to form psilocin.

30. The method of claim 29, wherein step (1) comprises:
(1-a) reacting 1H-indol-4-yl acetate with oxalyl chloride to form 3-(2-chloro-2-oxoacetyl)-1H-indol-4-yl acetate; and
(1-b) reacting the 3-(2-chloro-2-oxoacetyl)-1H-indol-4-yl acetate with dimethylamine to form 3-([(dimethylcarbamoyl)carbonyl])-1H-indol-4-yl acetate.

31. The method of claim 30, wherein the reacting in step (1-a) is conducted in a mixture of tert-butyl methyl ether (TBME) and THF.

32. The method of claim 30, wherein the reacting in step (1-a) is conducted at a temperature from about 30° C. to about 40° C.

33. The method of claim 29, wherein dimethylamine is used in excess in step (1-b).

34. The method of claim 1, wherein the yield of psilocybin from psilocin is about 50% or greater.

35. The method of claim 1, wherein the yield of psilocybin from 1H-indol-4-yl acetate is about 25% or greater.

36. The method of claim 2, wherein the crystalline form of psilocybin is characterized by XRPD peaks at 11.5±0.1, 12.0±0.1, 14.5±0.1, 17.5±0.1, and 19.7±0.1°2θ.

37. The method of claim 1, wherein the yield of the crystalline form of psilocybin from psilocin is about 40% or greater.

38. The method of claim 1, wherein the psilocybin has a chemical purity of greater than 99% as determined by HPLC analysis.

39. (canceled)

40. The method of claim 1, wherein the method manufactures the crystalline form of psilocybin at a scale greater than 500 g.

41. A method of manufacturing psilocybin from psilocin, comprising:
(i) mixing psilocin and TBPP in the presence of isopropylmagnesium chloride lithium chloride complex ((CH₃)₂CHMgCl·LiCl) at a temperature from about −10° C. to about 25° C. to form a reaction mixture; and
(ii) subjecting the reaction mixture to hydrogen in the presence of a catalyst to form psilocybin.

42. The method of claim 41, further comprising:
(iii) crystallizing the psilocybin from water, thereby forming a crystalline form of psilocybin.
